(19) United States
(12) Patent Application Publication
(10) Pub. No.: US 2011/0197172 A1
(43) Pub. Date: Aug. 11, 2011

(54) Design verification apparatus and design verification program

(75) Inventors: Tatsuya Yamamoto, Kawasaki (JP); Praveen Kumar Murthy, Fremont, CA (US); Rafael Kazumiti Morizawa, Kawasaki (JP)

(73) Assignee: FUJITSU LIMITED, Kawasaki (JP)

(21) Appl. No.: 12/805,141

(22) Filed: Jul. 14, 2010

Related U.S. Application Data
(60) Provisional application No. 61/302,736, filed on Feb. 9, 2010.

(51) Int. Cl. G06F 17/50

(52) U.S. Cl. 716/111

(57) ABSTRACT

A design verification apparatus includes a processor to produce and place constraint conditions on verification datasets provided to verify a first design specification of a target product. The processor produces those constraint conditions from a second design specification of the target product, based on links from units of processing which constitute a procedure defined for each verification item in the second design specification to units of processing in the first design specification. The processor outputs data identifying the resulting verification datasets having the constraint conditions, together with their corresponding verification items.

### CROSS-REFERENCE TO RELATED APPLICATION(S)

This application is based upon and claims the benefit of priority of U.S. Provisional Application No. 61/302,736, filed on Feb. 9, 2010, the entire contents of which are incorporated herein by reference.

### FIELD

The embodiments discussed herein relate to an apparatus and a program for performing design verification.

### BACKGROUND

Design verification is part of the development process of software and hardware products, which permits the designer to pursue his or her design process while ensuring that the product under development will work as intended. Generally the designer is allowed to write two or more design specifications for a single product design. In the case of, for example, developing an electronic circuit, the designer may write circuit specifications as a collection of functions that the circuit is supposed to offer. (See, for example, Japanese Laid-open Patent Publication No. 2004-185592.) In addition to those functional specifications, the circuit design may include power management specifications described according to the Common Power Format (CPF), Unified Power Format (UPF), or the like, so as to specify the interaction of control signals for power management of the circuit.

The design specifications may be modified as necessary during the course of development. A change made to one of the design specifications, however, could affect other design specifications. In the aforementioned electronic circuit development, a design change made to the circuit implementation necessitates a task of estimating power consumption of the modified circuit. Depending on the result of this power estimation, another design change may become necessary. This sort of iteration occurs in each phase of the development process.

As noted above, an electronic circuit design may include power management specifications. The design process begins with an architecture-level description of the entire circuit and then proceeds to more specific implementation of individual control features. Suppose, for example, that the power management specification uses clock gating as a power saving technique. In this case, a register transfer level (RTL) description of the circuit is generated and subjected to a structural analysis, so that the CAD software tools can turn it into another RTL description suitable for implementation of clock gating mechanisms in the subsequent stage of logic synthesis, or so that the designer can do the same manually.

When estimating the circuit's power consumption as a consequence of a design change, the designer runs a test by using test vectors prepared for verification of the circuit functions. This test yields an estimated power consumption, and if the result does not fall in the range of desired power consumption, the designer changes the implementation again.

The above method, however, has a drawback in its ability to perform a comprehensive test of power management specifications because it relies on the functional test vectors. In other words, it is difficult to verify whether the control signals are exchanged correctly to achieve the desired power management. This drawback is not only of the power management specifications. That is, the conventional method has difficulty in verifying whether the product under development works correctly as defined in other given design specifications.

### SUMMARY

There is provided a design verification apparatus including a processor to produce and place constraint conditions on verification datasets provided to verify a first design specification of a target product, the constraint conditions being produced from a second design specification of the target product, based on links from units of processing which constitute a procedure defined for each verification item in the second design specification to units of processing in the first design specification, and to output data identifying the verification datasets with the constraint conditions placed by the constraint setting module, together with the verification items corresponding thereto.

The object and advantages of the invention will be realized and attained by means of the elements and combinations particularly pointed out in the claims.

It is to be understood that both the foregoing general description and the following detailed description are exemplary and explanatory and are not restrictive of the invention, as claimed.

### BRIEF DESCRIPTION OF DRAWINGS

FIGS. 1 and 2 explain a design verification apparatus according to a first embodiment;

FIG. 3 illustrates a specific example of how constraint conditions are added;

FIG. 4 illustrates a system according to a second embodiment;

FIG. 5 illustrates a structure of an LSI design specification according to the second embodiment;

FIG. 6 illustrates an example data structure of an LSI design specification;

FIG. 7 illustrates relationships between message sequence charts, as well as their hierarchical structure;

FIG. 8 illustrates a structure of a message sequence chart;

FIG. 9 illustrates another example of a message sequence chart;

FIG. 10 illustrates a hardware configuration of a design verification apparatus;

FIG. 11 is a block diagram illustrating functions provided in the design verification apparatus;

FIG. 12 illustrates an example data structure of a power management specification;

FIG. 13 illustrates an example of a mode table;

FIG. 14 illustrates an example of a precondition table;

FIG. 15 is a flowchart depicting a general process flow of the design verification apparatus;

FIGS. 16 and 17 provide a flowchart illustrating a verification scenario generation process;

FIG. 18 is a flowchart illustrating a labeling process;

FIG. 19 is a flowchart illustrating a constraint setting process;

FIG. 20 is a flowchart illustrating a mode table generation process;

FIG. 21 is a flowchart illustrating a precondition table generation process;

FIG. 22 illustrates an example data structure of an LSI design specification;

FIGS. 23A to 23C illustrate examples of message sequence charts;

FIGS. 24A, 24B, 25A, 25B, 26A, and 26B provide an example of how labels are added to an LSI design specification;

FIG. 27 illustrates an example data structure of a labeled LSI design specification;

FIGS. 28A and 28B provide another example of how labels are added to an LSI design specification;

FIG. 29 is a message sequence chart which is to be converted into a finite state machine;

FIG. 30 illustrates a state matrix corresponding to the message sequence chart of FIG. 29;

FIG. 31 is a state diagram corresponding to the state matrix of FIG. 30;

FIG. 32 gives an example of how labels are added to a finite state machine;

FIG. 33 depicts a final view of the labeled finite state machine;

FIG. 34 is another state diagram corresponding to the state matrix;

FIG. 35 illustrates an example data structure of a finite state machine;

FIG. 36 illustrates verification scenarios stored in a verification scenario database;

FIG. 37 illustrates an example of a power management specification;

FIG. 38 illustrates an example of how to create a mode table and a precondition table;

FIG. 39 illustrates a directed graph representing power management verification scenarios;

FIGS. 40 and 41 illustrate a data structure of power management verification scenarios;

FIG. 42 illustrates a scenario list;

FIGS. 43A and 43B illustrate a case where power gating conditions are added to the power management specification;

FIG. 44 is a functional block diagram of a decoder circuit;

FIG. 45 illustrates a message sequence chart with a voltage condition specifying a voltage for the entire decoder circuit;

FIG. 46 illustrates an example layout of functions of the decoder circuit; and

FIG. 47 illustrates a power management specification with voltage conditions.

### DESCRIPTION OF EMBODIMENTS

Embodiments of the present invention will be described below with reference to the accompanying drawings, wherein like reference numerals refer to like elements throughout. The following description begins with an overview of a design verification apparatus according to a first embodiment and then proceeds to a second embodiment to deliver more specific explanations.

### First Embodiment

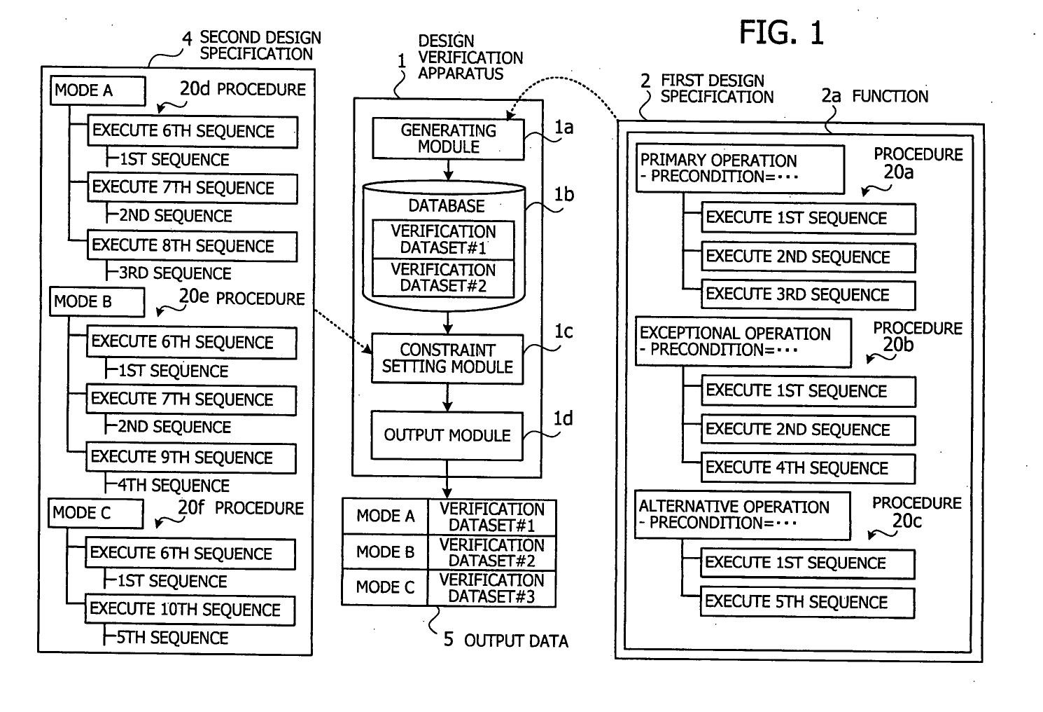

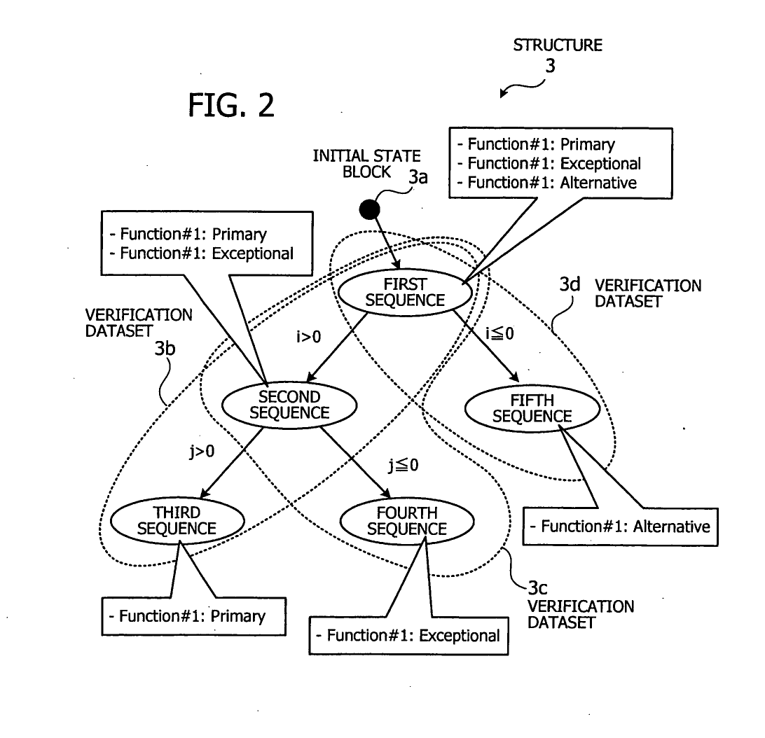

FIGS. 1 and 2 explain a functional structure of a design verification apparatus according to a first embodiment. The illustrated design verification apparatus 1 includes a generating module 1a, a database 1b, a constraint setting module 1c, and an output module 1d.

The generating module 1a generates verification datasets for verification of a first design specification 2 of a target product. Here the term “target product” refers to a specific object that is to be tested and verified by the design verification apparatus 1. The target product may be, for example, hardware components, software modules, or a system thereof. The design specification of such a target product is formed from at least one function and describes what its implementation should comply with.

FIG. 1 illustrates a function 2a as part of the first design specification 2. This function 2a is realized by three constituent procedures (or processing scenarios) 20a, 20b, and 20c. One procedure 20a defines a primary operation of the function 2a. Another procedure 20b defines an exceptional operation, and yet another procedure 20c defines an alternative operation. Where appropriate, those procedures 20a, 20b, and 20c may include all or some of precondition, postcondition, and invariant condition as their execution constraint conditions (guard conditions).

Specifically, preconditions are what have to be satisfied (i.e., conditions that return a value of “true” when tested) before starting a defined series of operations to execute a function. Postconditions are what have to be satisfied when such a series of operations is completed. Invariant conditions are what are supposed to be satisfied until the postconditions become true (i.e., during the course of a series of operations). As an example of such conditions, FIG. 1 illustrates preconditions for the primary, alternative, and exceptional operations.

Each procedure 20a to 20c has a branch structure in which the nodes represent units of processing to be executed by the defined operation (e.g., primary operation in the case of procedure 20a). Those units of processing may be, for example, message sequence charts (MSC) that define interactions between all objects involved in the function 2a. See, for example, U.S. Pat. No. 7,275,231 for more information about message sequence charts.

The relationships between procedures 20a to 20c are depicted in FIG. 2 in the form of a structure 3. This structure 3 visualizes the first design specification 2 in a compact way, in which an initial state block and first to fifth sequences are associated by branches and merges that indicate their relationships. The arrows connecting those sequence blocks indicate in what order the described functions are executed. Specifically, the procedure 20a starts at the initial state block and executes the first sequence, second sequence, and third sequence in that order. The procedure 20b starts at the initial state block and executes the first sequence, second sequence, and fourth sequence in that order. The procedure 20c starts at the initial state block and executes the first sequence and fifth sequence in that order.

As can be seen from FIG. 2, the illustrated structure 3 indicates that those three procedures operate in the same way up to the first sequence, but will then be diverted into different operations. The illustrated structure 3 also indicates that the procedures 20a and 20b operate in the same way up to the second sequence, but will then be diverted into different operations.

The edges of this structure 3 are directional edges which are each given a specific constraint condition where appropriate. Those constraint conditions describe under what conditions a transition takes place from one sequence to another sequence. For example, FIG. 2 illustrates an unconditional transition from the initial state block 3a to the first sequence. The process is allowed to proceed from the first sequence to the second sequence if i>0 when the first sequence is finished. Likewise, the process proceeds from the second sequence to the third sequence if j>0 when the second sequence is finished. If j≦0 when the second sequence is finished, the process proceeds instead to the fourth sequence. FIG. 2 also illustrates that the process proceeds from the first sequence to the fifth sequence if i≦0 when the first sequence is finished.

Verification datasets are used to verify a specific procedure (e.g., whether the procedure works as it is intended). Some verification datasets may include identifiers that designate which portions of the given design specification is to be verified. When this is the case, an identifier (label) indicating a specific portion of the design specification is associated with individual units of processing which constitute a procedure. Specifically, for the function 2a illustrated in FIG. 1, the generating module 1a produces a verification dataset which associates each of the first to third sequences of the procedure 20a of primary operation with the identifiers designating a specific portion of the design specification to be verified. What is verified in this case is a function, procedure, or unit of processing of the given design specification. In the example of FIG. 2, the first to third sequences are each associated with an identifier “Function#1” representing the function 2a, as well as with another identifier “Primary” (denoting primary operation) representing the procedure 20a.

The generating module 1a also produces a verification dataset for another procedure 20b describing exceptional operation of the function 2a, so as to associate each of the first, second, and fourth sequences with a relevant portion of the given design specification. In the example of FIG. 2, the first, second, and fourth sequences are each associated with an identifier “Function#1” representing the function 2a and another identifier “Exceptional” (denoting exceptional operation) representing the procedure 20b.

The generating module 1a further produces a verification dataset for yet another procedure 20c describing alternative operation of the function 2a, so as to associate each of the first and fifth sequences with a relevant portion of the given design specification. In the example of FIG. 2, the first and fifth sequences are each associated with an identifier “Function#1” representing the function 2a and another identifier “Alternative” (denoting alternative operation) representing the procedure 20c.

As a result of the above processing of the generating module 1a, the first sequence has gained three lines of identifiers, which read: “Function#1: Primary,” “Function#1: Exceptional,” and “Function#1: Alternative.” The second sequence has gained two lines of identifiers, which read: “Function#1: Primary” and “Function#1: Exceptional.” The third sequence has gained a single line of identifiers “Function#1: Alternative.” The fourth sequence has gained a single line of identifiers “Function#1: Exceptional.” The fifth sequence has gained a single line of identifiers “Function#1: Alternative.”

The generating module 1a then identifies sequences sharing a particular identifier and extracts each such set of sequences as a verification dataset. In the present example of FIG. 2, the first, second, and third sequences constitute one verification dataset 3b for “Primary” operation. This verification dataset 3b provides information for testing primary operation of the function 2a. Likewise, the first, second, and fourth sequences constitute another verification dataset 3c for “Exceptional” operation. This verification dataset 3c provides information for testing exceptional operation of the function 2a. Also, the first and fifth sequences constitute yet another verification dataset 3d for “Alternative” operation. This verification dataset 3d provides information for testing alternative operation of the function 2a.

Referring back to FIG. 1, there is illustrated a second design specification 4 including several different verification items, namely, Mode A, Mode B, and Mode C. Each mode has its own procedure, or processing scenario. Specifically, Mode A has a procedure 20d. Mode B has a procedure 20e. Mode C has a procedure 20f.

Those procedures 20d to 20f have their own branch structures in which each node represents a specific unit of processing to be executed in the corresponding mode. Specifically, the procedure 20d is to execute, as its units of processing, the sixth sequence, seventh sequence, and eighth sequence in that order. Likewise, the procedure 20e is to execute the sixth sequence, seventh sequence, and ninth sequence in that order. The procedure 20f is to execute the sixth sequence and tenth sequence in that order.

The constraint setting module 1c produces constraint conditions, based on the procedures 20d to 20f of each mode described in the second design specification 4 of the target product. The constraint setting module 1c then adds those constraint conditions to the verification datasets 3b, 3c, and 3d. For example, some links are previously defined from the units of processing of each procedure 20d to 20f to those of the verification dataset 3b, 3c, and 3d. The constraint setting module 1c uses these links to determine which constraint condition is assigned to which verification dataset 3b, 3c, and 3d.

In the example of FIG. 1, the sixth sequence has a link to the first sequence, indicating that the sixth sequence is associated with the first sequence. Likewise, the seventh sequence has a link to the second sequence, and the eighth sequence has a link to the third sequence. Also, the ninth sequence has a link to the fourth sequence, and the tenth sequence has a link to the fifth sequence.

As mentioned above, the constraint setting module 1c produces constraint conditions from the second design specification 4. According to the present embodiment, each produced constraint condition gives a condition specifying transition to one of the procedures 20d to 20f whose units of processing are linked to a particular unit of processing of the first design specification 2.

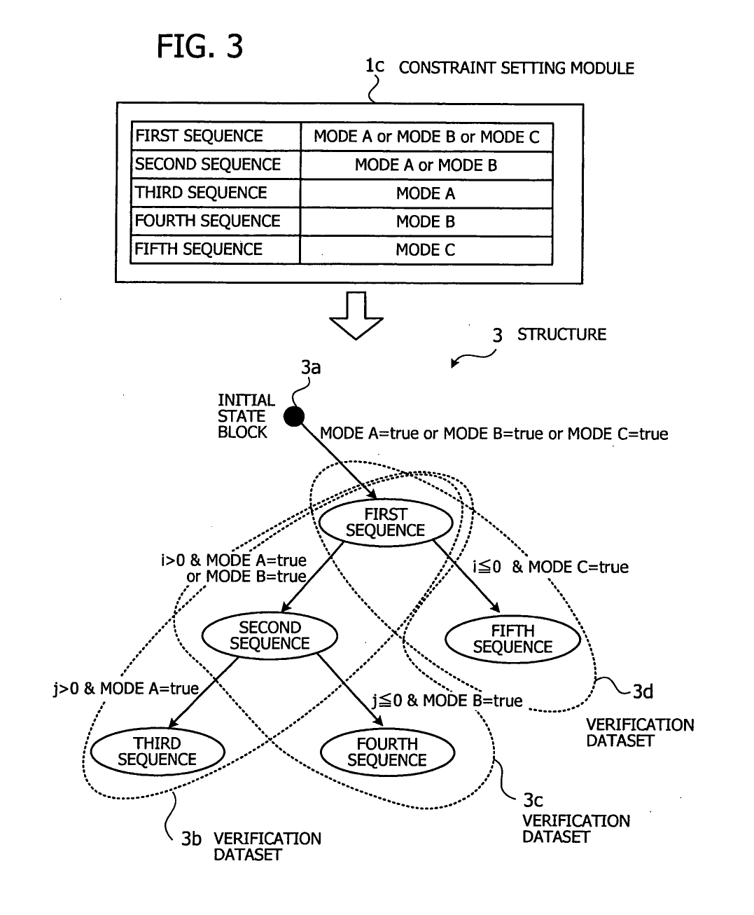

FIG. 3 illustrates a specific example of how constraint conditions are added to the structure of sequences discussed in FIG. 2, while omitting the identifiers of those sequences. As can be seen from FIG. 1, the sixth sequence having a link to the first sequence is included in all of the three procedures 20d to 20f. Accordingly, the constraint setting module 1c joins the mode names of those procedures 20d to 20f by using “or” operator, so as to indicate that the procedures 20d to 20f contain a sequence linked to the first sequence in the first design specification 2. More specifically, the three mode names “Mode A,” “Mode B,” and “Mode C” are joined together, thus forming a precondition for the first sequence. The constraint setting module 1c thus associates this precondition with the first sequence.

Likewise, the seventh sequence having a link to the second sequence is included in two procedures 20d and 20e. Accordingly, the constraint setting module 1c joins the mode names of those two procedures 20d and 20e by using “or” operator, so as to indicate that the procedures 20d and 20e contain a sequence linked to the second sequence. More specifically, two mode names “Mode A” and “Mode B” are joined together, thus forming a precondition for the first sequence. The constraint setting module 1c then associates this precondition with the second sequence.

The eighth sequence having a link to the third sequence is included in one procedure 20d. Accordingly, the constraint setting module 1c selects the mode name “Mode A” of that procedure 20d as a precondition for the third sequence, so as to indicate that the procedure 20d contains a sequence linked to the third sequence. The constraint setting module 1c then associates this precondition with the third sequence.

The ninth sequence having a link to the fourth sequence is included in one procedure 20e. Accordingly, the constraint setting module 1c selects the mode name “Mode B” of that procedure 20e as a precondition for the fourth sequence, so as to indicate that the procedure 20e contains a sequence linked to the fourth sequence. The constraint setting module 1c then associates this precondition with the fourth sequence.

The tenth sequence having a link to the fifth sequence is included in one procedure 20f. Accordingly, the constraint setting module 1c selects the mode name “Mode C” of that procedure 20f as a precondition for the fifth sequence, so as to indicate that the procedure 20f contains a sequence linked to the fifth sequence. The constraint setting module 1c then associates this precondition with the fifth sequence.

The constraint setting module 1c gives the above preconditions to the verification datasets 3b to 3d in the database 1b as their additional constraint conditions. More specifically, the constraint setting module 1c adds a precondition indicating that a transition from the initial state block 3a to the first sequence takes place when any of the three procedures of “Mode A,” “Mode B,” and “Mode C” is selected.

The constraint setting module 1c also adds another precondition indicating that a transition from the first sequence to the second sequence takes place when either of two procedures of “Mode A” and “Mode B” is selected. Since the second sequence already has a precondition i>0, the constraint setting module 1c uses “&” operator to connect the above new precondition with the existing precondition i>0. Accordingly, the transition from first sequence to second sequence will occur if i>0 while the procedure of either “Mode A” or “Mode B” is selected.

The constraint setting module 1c adds yet another precondition indicating that a transition from the second sequence to the third sequence takes place when the procedure of “Mode A” is selected. Since the third sequence already has a precondition j>0, the constraint setting module 1c uses “&” operator to connect the above new precondition with the existing precondition j>0. Accordingly, the transition from second sequence to third sequence will occur if j>0 while the procedure of “Mode A” is selected.

The constraint setting module 1c adds still another precondition indicating that a transition from the second sequence to the fourth sequence takes place when the procedure of “Mode B” is selected. Since the fourth sequence already has a precondition j≦0, the constraint setting module 1c uses “&” operator to connect the above new precondition with the existing precondition j≦0. Accordingly, the transition from second sequence to fourth sequence will occur if j≦0 while the procedure of “Mode B” is selected.

The constraint setting module 1c adds still another precondition indicating that a transition from the first sequence to the fifth sequence takes place when the mode name “Mode C” is selected as a procedure. Since the fifth sequence already has a precondition i≦0, the constraint setting module 1c uses “&” operator to connect the above new precondition with the existing precondition i≦0. Accordingly, the transition from first sequence to fifth sequence will occur if i≦0 while the procedure of “Mode C” is selected.

As can be seen from the above, the verification dataset 3b is the only verification dataset that implements the procedure 20d of “Mode A.” Similarly, the verification dataset 3c is the only verification dataset that implements the procedure 20e of “Mode B.” The verification dataset 3d is the only verification dataset that implements the procedure 20f of “Mode C.”

Referring back to FIG. 1, the output module 1d produces output data 5 to indicate the associations of verification datasets 3b to 3d with procedures of the second design specification 4. The illustrated output data 5 includes three records associating each particular mode name with a relevant verification dataset. That is, one record associates “Mode A” with “Verification Dataset #1” indicating the verification dataset 3b in FIG. 3. Another record associates “Mode B” with “Verification Dataset #2” indicating the verification dataset 3c in FIG. 3. Yet another record associates “Mode C” with “Verification Dataset #3” indicating the verification dataset 3d in FIG. 3.

As can be seen from the above discussion, the proposed design verification apparatus 1 employs a constraint setting module 1c to produce constraint conditions from the second design specification 4 of the target product and incorporate those constraint conditions into verification datasets 3b, 3c, and 3d. With these features, the proposed design verification apparatus 1 can provide verification datasets 3b, 3c, and 3d including every relevant constraint condition for each test item of the design specification.

The user verifies his or her design with each mode-specific verification dataset 3b, 3c, and 3d which provides a comprehensive test of control signals defined in the second design specification 4, without leaving out necessary test items or duplicating the same test items. That is, the additional constraint conditions of mode take effect on procedures 20a to 20c, meaning that procedures failing to fulfill the constraint conditions of a certain mode will be excluded from the verification dataset of that mode. It is ensured, on the other hand, that necessary verification datasets are fully provided for a procedure that satisfies the constraint conditions of mode.

Suppose, for example, that the user is going to test the operation in Mode C. The constraint condition on the second sequence evaluates to false in this case, meaning that there will be no transition to the second sequence. Verification datasets 3b and 3c including transition to the second sequence are therefore excluded from the Mode-C test. Accordingly, the user has only to execute the verification dataset #3 when testing the procedure 20f of “Mode C.”

While the design verification apparatus 1 of the present embodiment contains a generating module 1a to produce verification datasets, the invention is not limited by this specific feature. For example, the design verification apparatus 1 may also be configured to receive verification datasets that have been produced by some other devices, so that the constraint setting module 1c can give constraint conditions to the received verification datasets. The design verification apparatus 1 in this case may omit the foregoing functions of the generating module 1a and database 1b.

Also, the present embodiment is configured to produce verification datasets that associate specific portions of a given design specification with each sequence constituting a procedure. The embodiment may be modified to assign a priority level to each verification dataset, depending on which portions of the given design specification are to be verified and what their process priorities are. The generating module 1a, however, has only to produce such verification datasets that clarify which sequence is included in each procedure. It is thus possible to omit the task of associating specific portions of the design specification with each sequence constituting a procedure.

### Second Embodiment

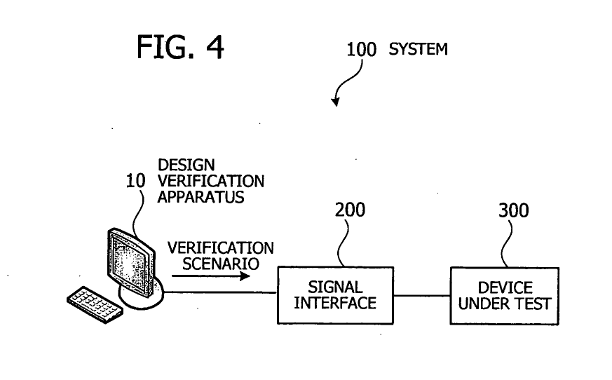

This section will describe a more specific embodiment of the design verification apparatus discussed above. FIG. 4 illustrates a system according to a second embodiment. The illustrated system 100 is formed from a design verification apparatus 10, a signal interface 200, and a device 300 under test. The design verification apparatus 10 is used to determine whether the device 300 under test will operate as described in its design specification. To this end, the design verification apparatus 10 produces a verification scenario for each processing scenario described in the design specification. The design verification apparatus 10 then assigns priorities to the produced verification scenarios. The design verification apparatus 10 further interacts with the device 300 via a signal interface 200 so as to test whether the device 300 can operate in accordance with those prioritized verification scenarios. In this test process, the priority scores of verification scenarios are used to determine in what order those scenarios should be applied to the device 300.

The signal interface 200 is a device that permits the design verification apparatus 10 to communicate with the device 300 by converting their signals into suitable form of each other. This signal interface 200 may be omitted in the case where, for example, the design verification apparatus 10 and device 300 are compatible in their signal specifications.

The device 300 under test (hereafter, device 300) is what will be tested and verified by the design verification apparatus 10, which may be hardware components, software modules, or a system containing the like. The device 300 may be a physical device such as a product prototype manufactured in the course of product development, or a logical simulation model such as a state machine created on the design verification apparatus 10. The following description assumes that a large-scale integration (LSI) circuit is under development and thus subjected to the design verification.

### (a) Design Specification of LSI Circuit

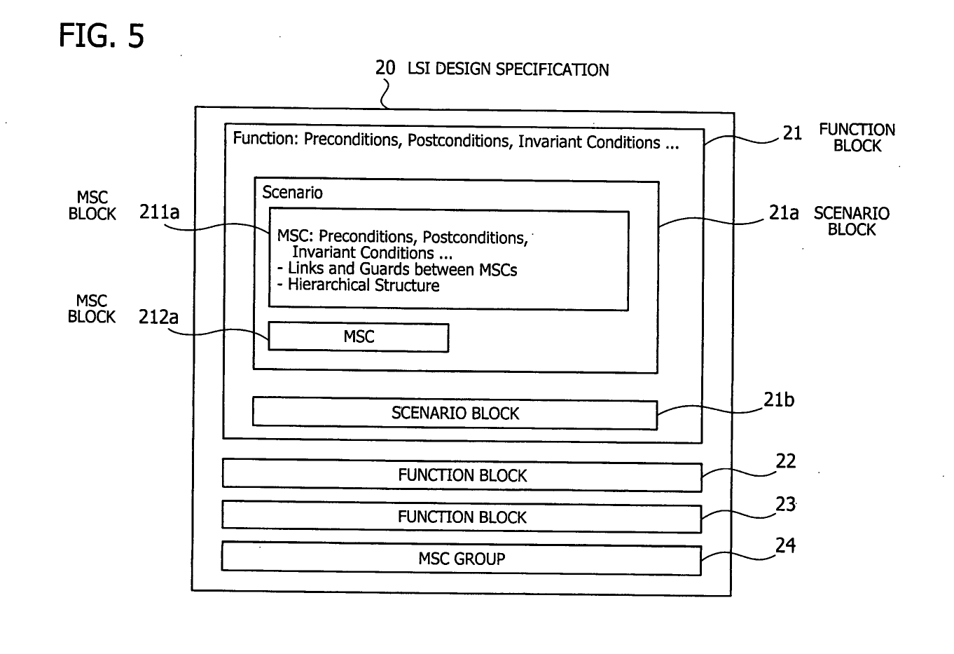

FIG. 5 illustrates a structure of an LSI design specification according to the second embodiment. As mentioned earlier, the design specifications describe what the implementation should comply with. A design specification is provided as a collection of functions. For example, the illustrated LSI design specification 20 is organized in a list structure using the Extensible Markup Language (XML).

Each function block 21, 22, and 23 describes a single function, which may be, for example, a hardware function called up by a software module, or a software function dependent on some hardware components. Each of those function blocks 21, 22, and 23 has one or more scenario blocks. Specifically, the illustrated function block 21 has two scenario blocks 21a and 21b, each describing a single scenario. Those scenarios are the substantive part of the described function. One function may include two or more scenarios corresponding to different calling conditions. More specifically, a scenario defines a series of operations that will be executed to realize an intended function. To put it in another way, a scenario gives an ordered set of messages exchanged between objects.

Each scenario block 21a and 21b contains one or more message sequence chart (MSC) blocks. In the example of FIG. 5, the illustrated scenario block 21a contains two MSC blocks 211a and 212a. These MSC blocks 211a and 212a are each associated with a single message sequence chart.

Message sequence charts give a set of sub-functions offered by the scenario. More specifically, message sequence charts provide a clear definition of what interactions will be made between objects involved in the function. Such objects may include functions described in the LSI design specification 20, as well as an external environment which may interact with the system including that LSI circuit.

### (b) Data Structure of LSI Design Specification

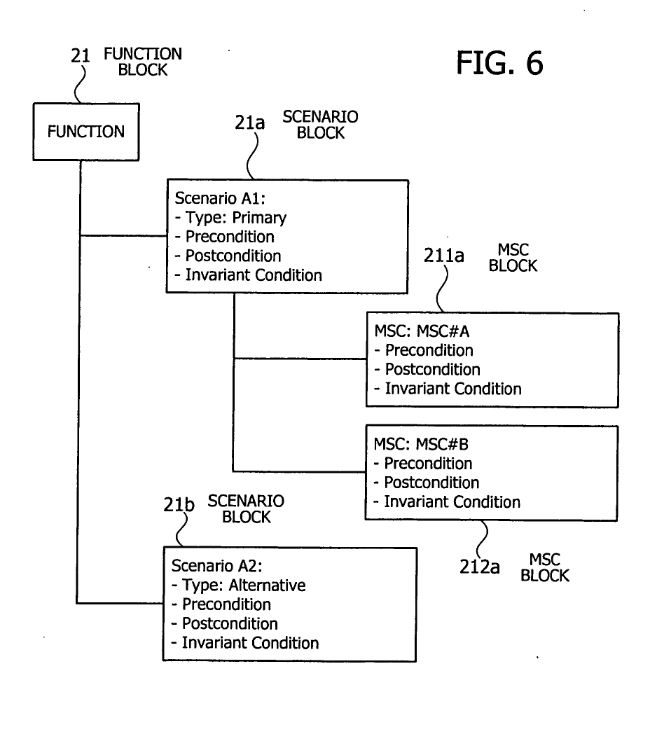

Referring to FIG. 6, an example data structure of an LSI design specification is illustrated. As noted above, the LSI design specification 20 is provided as a collection of functions. FIG. 6 depicts the same design specification of FIG. 5 now in tree form, with a focus on one function.

A function may include all or some of preconditions, post conditions, and invariant conditions as its constraint conditions. The function block contains a description of such conditions if any. In the case where there are no such conditions to apply, they contain an indication of “No Conditions” to state that fact. When, for example, the function has only a precondition, its postcondition and invariant condition are defined to be “No Conditions.”

As described above, the function block 21 defines a function which includes two scenarios A1 and A2 represented by scenario blocks 21a and 21b, respectively. Each scenario A1 and A2 bears a specific property, i.e., “Primary” (primary operation) or “Alternative” (alternative operation) or “Exceptional” (exceptional operation). The scenario blocks 21a and 21b indicate this property under the title of “Type.” In addition, those scenarios A1 and A2 may include all or some of preconditions, postconditions, and invariant conditions as their constraint conditions. Scenario blocks contain a description of such conditions if any. In the case where there are no such conditions to apply, they contain an indication of “No conditions.” In the example of FIG. 6, scenario A1 of primary operation includes a precondition, a postcondition, and an invariant condition, as does scenario A2 of alternative operation.

Message sequence charts of MSC blocks 211a and 212a are distinguished by their respective identifiers (MSC names), “MSC#A” and “MSC#B.” Message sequence charts may include all or some of preconditions, postconditions, and invariant conditions. MSC blocks contain a description of such conditions if any. In the case where there are no such conditions to apply, they contain an indication of “No Conditions” to state that fact.

In the example of FIG. 6, one message sequence chart “MSC#A” includes a precondition, postcondition, and invariant condition, as does the other message sequence chart “MSC#B”. While FIG. 6 does not illustrate it explicitly, another scenario block 21b has at least one MSC block.

The LSI design specification 20 may be represented as a single directed graph including a plurality of message sequence charts. Alternatively, it may also be represented as a single message chart with a flat structure. In the latter case, the flattened message sequence chart indicates the order of messages exchanged between objects. As yet another alternative method, the LSI design specification 20 may be represented as a plurality of cross-embedded directed graphs and a plurality of message sequence charts.

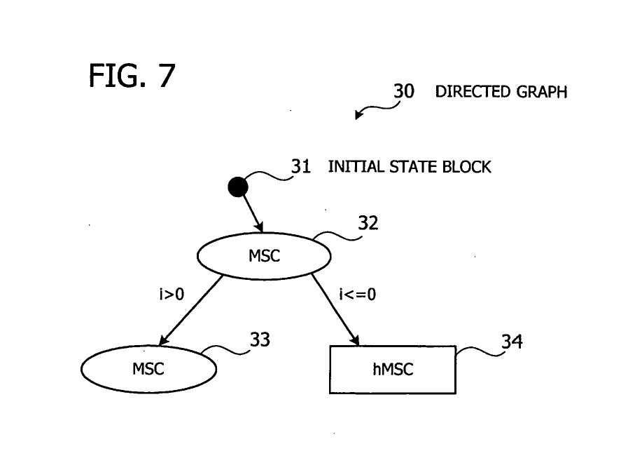

FIG. 7 illustrates relationships between message sequence charts, as well as their hierarchical structure. According to the present embodiment, the LSI design specification 20 is hierarchically structured in the form of a directed graph 30. This directed graph 30 offers a compact representation of the LSI design specification 20.

The directed graph 30 includes a plurality of message sequence charts, as well as branches and merges that indicate relationships between those charts, as mentioned above. These relationships permit the message sequence charts to be sorted into one or more sequences.

Message sequence charts, on the other hand, describe relationships between objects. That is, each message sequence chart is used to identify messages exchanged between objects and figure out in what order at least part of such messages are transmitted.

The illustrated directed graph 30 describes relationships between a plurality of subordinate functions executed by a particular function to authenticate prospective users. These functions are defined and visualized by message sequence charts. Each message sequence chart corresponds to a specific function, and the arrows interconnecting blocks indicate the execution order of the functions. The edges of the directed graph 30 are directional edges with optional constraint conditions.

The directed graph 30 of FIG. 7 includes three functions represented by two distinct message sequence charts 32 and 33 and one h message sequence chart (hMSC) 34. Here the h message sequence chart 34 expresses a hierarchy of message sequence charts in a collective manner. The solid circle is an initial state block 31, which serves as a pseudo state to provide the directed graph 30 with an entry point. Specifically, the initial state block 31 specifies which message sequence chart will be activated in the first place. That is, the arrow drawn from this initial state block 31 to the message sequence chart 32 indicates that a message sequence of the message sequence chart 32 will be communicated immediately upon entry to the directed graph 30. This communication of messages is then followed by either the message sequence chart 33 or the h message sequence chart 34.

As can be seen from the above explanation, the illustrated directed graph 30 includes two scenarios. That is, one scenario corresponds to a path that runs from the initial state block 31 to the topmost message sequence chart 32, and then down to the bottom-left message sequence chart 33 in FIG. 7. The other scenario corresponds to a path that runs from the initial state block 31 to the message sequence chart 32 and then to the h message sequence chart 34. Accordingly, both scenarios operate in the same way up to the first message sequence chart 32, but will then be diverted into different operations.

The edges of the directed graph 30 are directional edges with constraint conditions. Upon completion of messages given by the current message sequence chart, the constraint condition of each relevant edge is evaluated. If either condition is met, then it triggers a transition to the corresponding destination message sequence chart. In the case of hMSC, the destination of transition is its constituent message sequence chart in the same hierarchical level.

In the example of FIG. 7, one constraint condition “i>0” brings the state from the current message sequence chart 32 to the next message sequence chart 33. In the case where the other constraint condition “i<=0” is met, the state moves instead to the h message sequence chart 34. This information serves effectively in making a complete verification of the directed graph 30 while avoiding duplicated execution of common portions of the two scenarios.

Note here that message sequence charts in the directed graph 30 may refer to the same set of objects. Also, the directed graph 30 may be associated with some rules requiring that every message defined in a certain message sequence chart be executed before the next message sequence chart on the path becomes executable. The next section will describe a typical structure of message sequence charts.

### (c) Message Sequence Chart

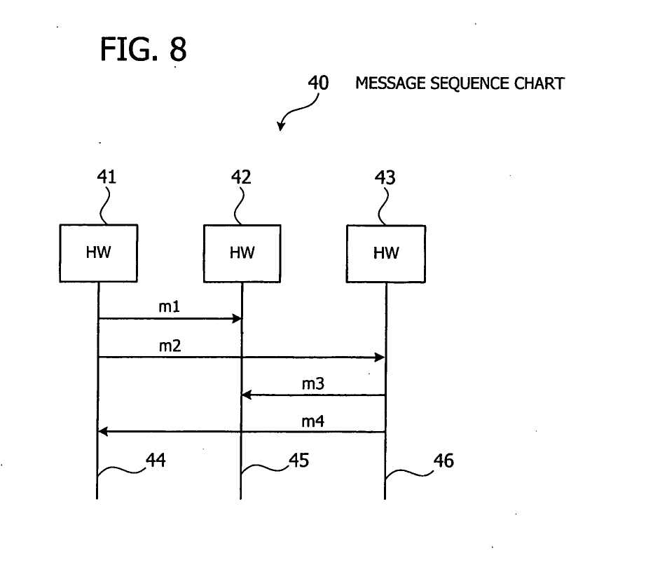

FIG. 8 illustrates a structure of a message sequence chart. As described earlier, message sequence charts provide a clear definition of what interactions will be made between objects involved in a function. Message sequence charts may involve, for example, hardware blocks of an LSI circuit under development or objects serving as an external environment which may interact with a system under development.

The message sequence chart 40 illustrated in FIG. 8 includes a plurality of hardware (HW) objects 41, 42, and 43 and depicts a series of data event messages to be exchanged after such objects are generated. Those data event messages may be specified by the user. That is, the user is allowed to specify what messages are communicated between which objects. For example, the user may select one object and then another object by using a pointing tool (not illustrated). The selected objects are formed into a message sequence chart 40 in which a data event message is sent from the first-selected object having a transmit event to the second-selected object having a receive event. The message sequence chart 40 is produced in the way described above to represent four data event messages m1 to m4 exchanged between hardware objects 41, 42, and 43 as indicated by the four arrows. As can be seen from the example of FIG. 8, object lines 44, 45, and 46 extend downward from the respective hardware objects 41, 42 and 43, and horizontal arrows are drawn between those object lines 44, 45, and 46 to represent inter-object data event messages.

Each data event message associates a transmitting object with a receiving object. The points at which those object lines 44, 45, and 46 meet data event messages m1 to m4 are called “events.” Every data event message includes a transmit event associated with its transmitting object and a receive event associated with its receiving object. For example, the topmost data event message m1 in FIG. 8 runs between two object lines 44 and 45, meaning that the data event message m1 associates one hardware object 41 and transmitting object with another hardware object 42 and receiving object. The data event message m1 further gives a transmit event at its one end point on the object line 44 and a receive event at its other end point on the object line 45.

Such object-event relationships defined in a message sequence chart are supposed to comply with the following two rules: The first rule requires that the transmit event s(m) of a data event message m precede its corresponding receive event r(m). This rule is expressed as s(m)<r(m). The second rule requires that the events on an object line be sequenced from the top to the bottom.

The above two rules mean that message sequence charts describe the order of data event messages between objects. For example, according to the first rule, the transmit event of data event message m1 occurs before the receive event of the same. According to the second rule, on the other hand, the transmit event of data event message m2 occurs before the receive event of data event message m4.

The same applies to other data event messages in FIG. 8. Referring to the time axis of the leftmost hardware object 41, data event messages m1 and m2 are transmitted in that order, and data event message m4 is received thereafter. On the time axis of the next hardware object 42, data event messages m1 and m3 arrive in that order. On the time axis of the rightmost hardware object 43, data event message m2 arrives first, and then data event messages m3 and m4 are transmitted in that order.

The above rules are transitive. For example, when event e1 precedes event e2 (i.e., e1<e2), and when event e2 precedes event e3 (e2<e3), this means that event e1 precedes event e3 (e1<e3).

The above two rules, however, may not necessarily govern all ordered relationships between data event messages. Think of, for example, a message sequence chart that contains four objects and only two data event messages. In this message sequence chart, a first data event message is sent from a first object to a second object, and a second data event message is sent from a third object to a fourth object. The foregoing two rules, however, provide no particular order of those two data event messages in this example case. That is, the two data event messages can be sent in either order.

The hardware objects 42 and 43 in the example of FIG. 8 do not share their ordinal relationships on the time axis. Accordingly, the topmost data event message m1 and second data event message m2 may swap their positions in the sequence. Likewise, the third data event message m3 and fourth data event message m4 may swap their positions since the hardware objects 41 and 42 do not share their ordinal relationships on the time axis.

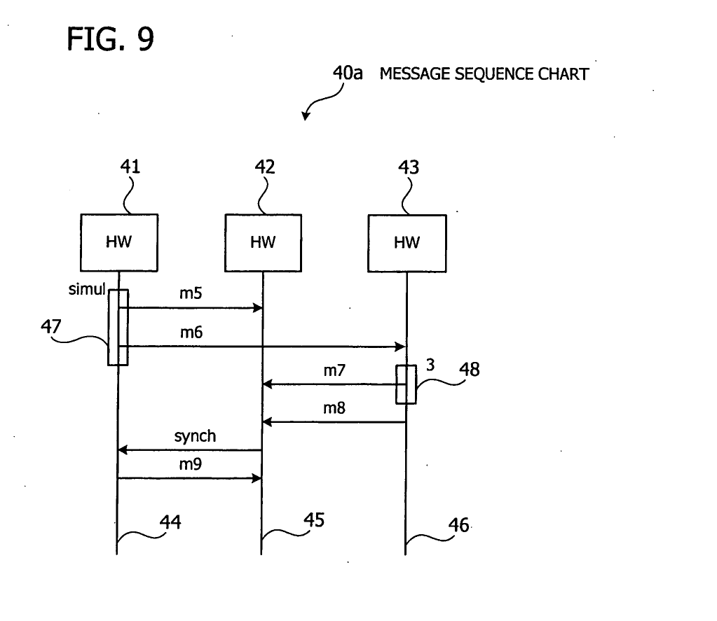

FIG. 9 illustrates another example of a message sequence chart. This message sequence chart 40a includes three hardware objects 41, 42, and 43, where the sequence is defined with three enhanced functions that are referred to as simultaneity constraint, timeout constraint, and synchronization edge.

FIG. 9 depicts a simultaneity constraint and a timeout constraint in the form of a box enclosing events. Specifically, the box 47 labeled “simul” represents a simultaneity constraint. This box 47 binds the enclosed events (i.e., two transmit events associated with data event messages m5 and m6) into a group of simultaneous events.

The box 48 represents a timeout constraint, with an integer number affixed to indicate a specific timeout value. When such a timeout constraint is encountered during the execution of a sequence, the execution is suspended until the specified timeout period expires. In this timed execution model, the sequence cannot resume until the expiration of a given timeout period. In the example of FIG. 9, data event message m7 is transmitted after a lapse of three unit times, as indicated by the label “3” beside the box 48.

Synchronization edges are used to establish a particular ordinal relationship between data event messages. Synchronization edges have the same appearance as ordinary data event messages, except that they are labeled “synch.” Data event messages having a label of “synch” will be referred to as synchronization messages. Think of, for example, a synchronization edge including a transmit event on one hardware object 42 and a receive event on another hardware object 41. In this case, a synchronization message is sent from the hardware object after it receives a data event message m8. This synchronization message is received by the hardware object 41 before it sends a data event message m9.

According to the message sequence chart 40a, the hardware object 42 is supposed to receive data event message m8 before the hardware object 41 sends data event message m9. A synchronization edge, when added, creates a relationship between multiple objects which are otherwise unrelated to each other. According to an embodiment, however, synchronization edges do not actually produce any messages to interrelate objects. In FIG. 9, the synchronization message actually produces a transmit event for data event message m9 after receive events of data event messages m7 and m8, rather than sequencing data event messages m5, m6, m7, and m8 by comparing m7 and m8 with m5 and m6.

### (d) Design Verification Apparatus

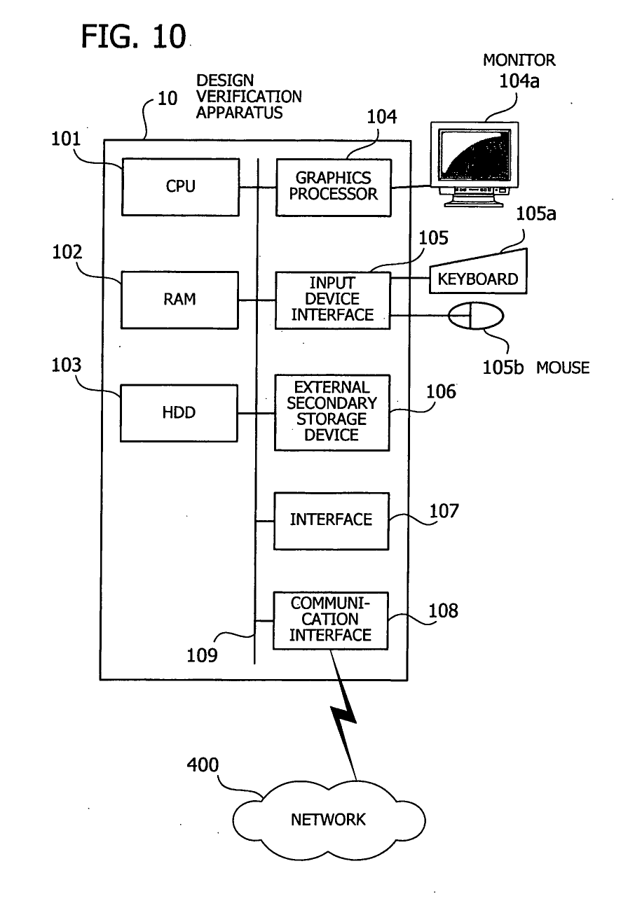

Referring now to FIG. 10, a hardware configuration of a design verification apparatus will be described below. The illustrated system has the following hardware elements: a central processing unit (CPU, processor) 101, a random access memory (RAM) 102, a hard disk drive (HDD) 103, a graphics processor 104, an input device interface 105, an external secondary storage device 106, an interface 107, and a communication interface 108. The CPU 101 controls the entire computer system of this design verification apparatus 10, interacting with other elements via a bus 109.

Specifically, the CPU 101 manipulates information received from the input device interface 105, external secondary storage device 106, interface 107, and communication interface 108. The RAM 102 serves as temporary storage for the whole or part of operating system (OS) programs and application programs that the CPU 101 executes, in addition to other various data objects manipulated at runtime. The HDD 103 stores program and data files of the operating system and applications. In addition, the HDD 103 stores list structures scripted with the Extensible Markup Language (XML).

The graphics processor 104, coupled to a monitor 104a, produces video images in accordance with drawing commands from the CPU 101 and displays them on a screen of the monitor 104a. The input device interface 105 is used to receive signals from external input devices, such as a keyboard 105a and a mouse 105b. Those input signals are supplied to the CPU 101 via the bus 109.

The external secondary storage device 106 reads data from, and writes data to a storage medium. Such storage media include magnetic storage devices, optical discs, magneto-optical storage media, and semiconductor memory devices, for example. Magnetic storage devices include hard disk drives (HDD), flexible disks (FD), and magnetic tapes, for example. Optical discs include digital versatile discs (DVD), DVD-RAM, compact disc read-only memory (CD-ROM), CD-Recordable (CD-R), and CD-Rewritable (CD-RW), for example. Magneto-optical storage media include magneto-optical discs (MO), for example.

The interface 107 is a hardware component configured to transmit data to and receive data from an external device connected to the design verification apparatus 10. Specifically, the interface 107 is used to communicate with a device 300 through a signal interface 200 (see FIG. 4). The communication interface 108 is connected to a network 400, allowing the CPU 101 to exchange data with other computers (not illustrated) on the network 400.

The computer described above serves as a hardware platform for realizing processing functions of the present embodiment. That is, the design verification apparatus 10 employs functions described below.

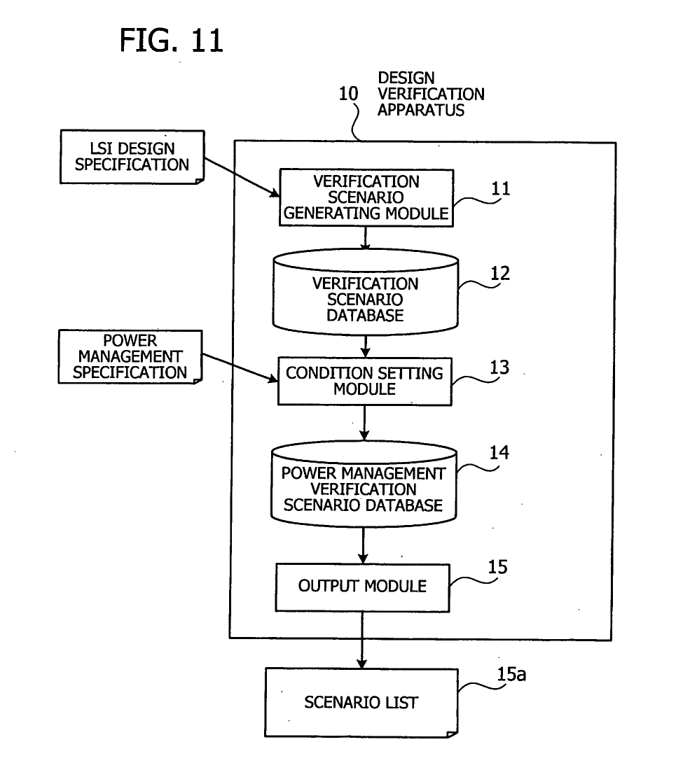

FIG. 11 is a block diagram illustrating functions provided in the design verification apparatus 10, which are: a verification scenario generating module 11, a verification scenario database 12, a condition setting module 13, a power management verification scenario database 14, and an output module 15. While not illustrated in FIG. 11, the design verification apparatus 10 may include some tools for generating message sequence charts or creating a state machine based on given message sequence charts.

The verification scenario generating module 11 produces a verification scenario for each processing scenario based on the data of an LSI design specification 20, which was previously discussed in FIGS. 5 and 6. A verification scenario is formed from message sequence charts of each processing scenario described in the given LSI design specification 20 and their respective labels (identifiers) obtained from that design specification. The labels designate which portion of the design specification (e.g., a specific function, scenario, or message sequence chart) is to be verified. Here the verification scenarios serve as intermediate data for subsequent processing to be performed by the condition setting module 13.

While not explicitly illustrated in FIG. 11, the verification scenario generating module 11 has a temporary memory to store data produced in the course of verification scenario generation. The verification scenario database 12 is where the verification scenarios produced by the verification scenario generating module 11 are stored for subsequent use.

The condition setting module 13 gives constraint conditions to the verification scenarios stored in the verification scenario database 12, based on a given power management specification that describes control signals for power control. When adding constraint conditions, the condition setting module 13 produces a mode table and a precondition table. The mode table indicates a mode corresponding to a message sequence chart associated with the given power management specification. The precondition table summarizes the associations between modes and message sequence charts appearing in the produced mode table. How to produce those tables will be described later.

Based on the information in the precondition table, the condition setting module 13 places constraint conditions on verification scenarios. The resulting version of the verification scenarios contains not only the information of the LSI design specification 20, but also some associated information of the power management specification. Those scenarios will thus be referred to as “power management verification scenarios.”

The condition setting module 13 saves the produced power management verification scenarios in a power management verification scenario database 14. The output module 15 outputs a scenario list 15a that enumerates the power management verification scenarios in a predetermined format.

### (e) Power Management Specification

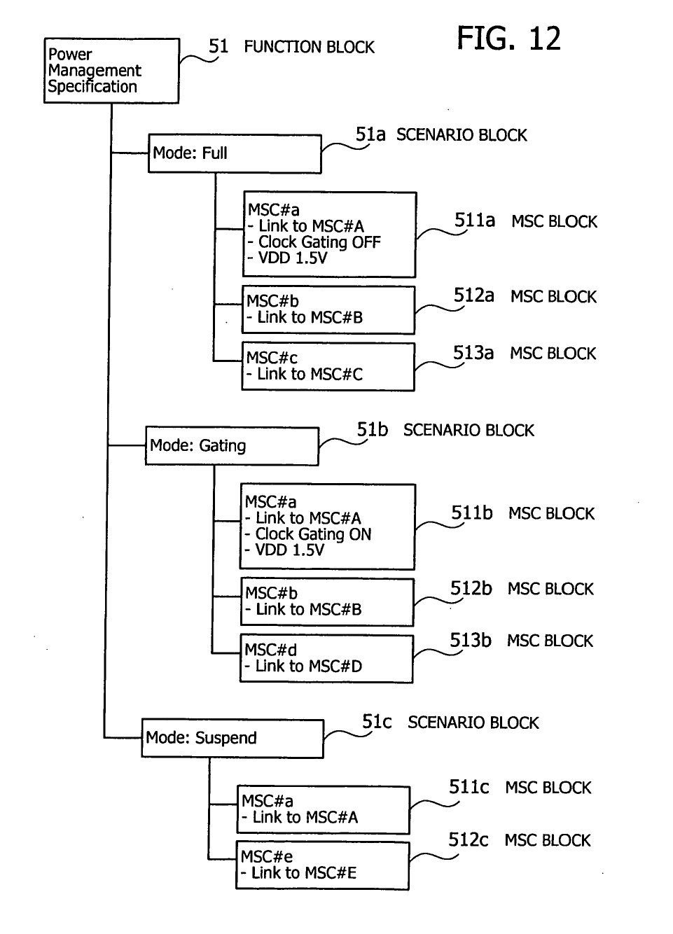

Referring now to FIG. 12, an example data structure of a power management specification will be described below. The power management specification is implemented with a plurality of scenarios describing different power operation modes. The power management specification of FIG. 12 is formed from three scenarios “Mode: Full,” “Mode: Gating,” and “Mode: Suspend” in scenario blocks 51a, 51b, and 51c, respectively.

Specifically, scenario “Mode: Full,” when executed, supplies a voltage to all circuits in the LSI circuit defined by the LSI design specification 20, without activating its clock gating functions. Scenario “Mode: Gating,” when executed, activates clock gating at specified portions of the LSI circuit. Scenario “Mode: Suspend” is a power-saving mode used to, for example, temporarily stop the use of the LSI circuit. When executed, this scenario saves current operating state of the LSI circuit in memory, so that the circuit can restore the state it was in before the power is removed.

Each scenario is implemented as one or more message sequence charts. Specifically, the first scenario block 51a has three MSC blocks 511a, 512a, and 513a. The second scenario block 51b also has three MSC blocks 511b, 512b, and 513b. The third scenario block 51c has two MSC blocks 511c and 512c.

The message sequence charts of those MSC blocks have distinguishable MSC names. For example, the message sequence charts of MSC blocks 511a, 511b, and 511c have an MSC name of “MSC#a.” The message sequence charts of MSC blocks 512a and 512b have an MSC name of “MSC#b.” The message sequence chart of MSC block 513a has an MSC name of “MSC#c.” The message sequence chart of MSC block 513b has an MSC name of “MSC#d.” The message sequence chart of MSC block 512c has an MSC name of “MSC#e.”

These message sequence charts are each linked to specific message sequence charts in the functional specification of the LSI circuit. For example, message sequence chart MSC#a has a link to message sequence chart MSC#A in FIG. 6. Those links of message sequence charts in the power management specification associate their respective preconditions with the constraint conditions of a function in the LSI design specification 20.

The power management specification may include all or some of preconditions, postconditions, and invariant conditions as constraint conditions on its message sequence charts. MSC blocks contain a description of such conditions if any.

Message sequence charts are allowed to have different constraint conditions even when they have the same MSC name. For example, scenario “Mode: Full” has a message sequence chart named “MSC#a” with a constraint condition of “Clock Gating OFF.” Scenario “Mode: Gating” also has a message sequence chart named “MSC#a.” While having the same MSC name, the latter message sequence chart is given a different constraint condition “Clock Gating ON.”

Some message sequence charts in the power management specification may contain a condition of operating voltage in a specific mode. For example, message sequence chart MSC#a in scenario “Mode: Full” has an operating voltage condition of 1.5V. Message sequence chart MSC#a in scenario “Mode: Gating” also has an operating voltage condition of 1.5V.

### (f) Mode Table and Precondition Table

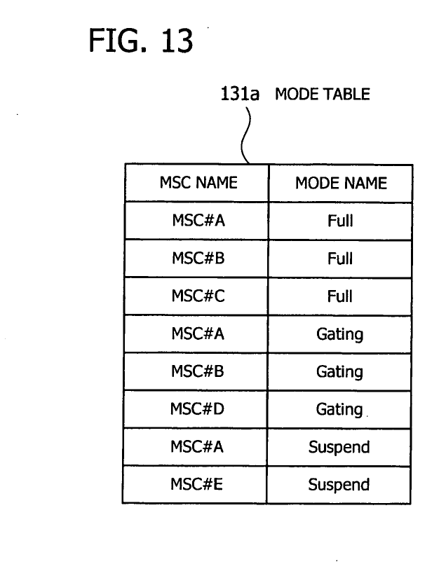

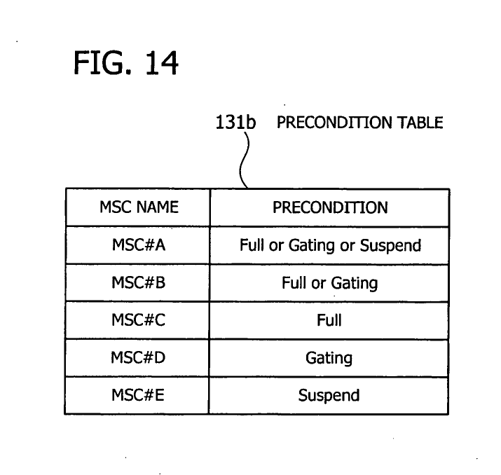

Referring now to FIGS. 13 and 14, this section will discuss a mode table and a precondition table. FIG. 13 illustrates an example of a mode table. This mode table 131a is formed from an MSC name field and a mode name field. The field values in a row are associated with each other, thus constituting a single record.

The mode table 131a contains MSC names indicating the link destination of each message sequence chart constituting mode scenarios in the power management specification. As discussed in FIG. 12, scenario “Mode: Full” has three message sequence charts identified by their MSC names, i.e., MSC#a, MSC#b, and MSC#c. These message sequence charts MSC#a, MSC#b, and MSC#c are linked to message sequence charts MSC#A, MSC#B, and MSC#C, respectively. Accordingly, the mode table 131a of FIG. 13 gives the MSC names of those link destinations MSC#A, MSC#B, and MSC#C in its MSC name field, together with a mode name “Full” in the corresponding mode name field. This mode name value “Full” indicates that the source message sequence charts MSC#a, MSC#b, and MSC#c linked to those destination message sequence charts MSC#A, MSC#B, and MSC#C belong to a scenario that is identified by the mode name of “Full” in the power management specification.

In addition to the above, scenario “Mode: Gating” has three message sequence charts identified by their MSC names, i.e., MSC#a, MSC#b, and MSC#d. These message sequence charts MSC#a, MSC#b, and MSC#d are linked to other message sequence charts MSC#A, MSC#B, and MSC#D, respectively. Accordingly, the mode table 131a of FIG. 13 gives the MSC names of those link destinations MSC#A, MSC#B, and MSC#D in its MSC name field, together with a mode name “Gating” in the corresponding mode name field. This mode name value “Gating” indicates that the source message sequence charts MSC#a, MSC#b, and MSC#d linked to those destination message sequence charts MSC#A, MSC#B, and MSC#D belong to a scenario that is identified by the mode name of “Gating” in the power management specification.

Furthermore, scenario “Mode: Suspend” has two message sequence charts identified by their MSC names MSC#a and MSC#e. These message sequence charts MSC#a and MSC#e are linked to other message sequence charts MSC#A and MSC#E, respectively. Accordingly, the mode table 131a of FIG. 13 gives the MSC names of those link destinations MSC#A and MSC#E in its MSC name field, together with a mode name “Suspend” in the corresponding mode name field. This mode name value “Suspend” indicates that the source message sequence charts MSC#a and MSC#e linked to those destination message sequence charts MSC#A and MSC#E belong to a scenario that is identified by the mode name of “Suspend” in the power management specification.

FIG. 14 illustrates an example of a precondition table. The illustrated precondition table 131b is formed from an MSC name field and a precondition field. The field values in a row are associated with each other, thus constituting a single record.

The MSC name field stores information indicating what message sequence charts are recorded in the MSC name field of the mode table 131a. Specifically, the precondition table 131b of FIG. 14 enumerates five MSC names “MSC#A” to “MSC#E” extracted from the MSC name field of the mode table 131a discussed in FIG. 13.

The precondition field contains mode names corresponding to each message sequence chart seen in the MSC name field. For example, the topmost record of the precondition table 131b of FIG. 14 contains three mode names “Full,” “Gating,” and “Suspend” in the precondition field corresponding to message sequence chart MSC#A. Note that those mode names are joined to each other by “or” operator.

The mode names seen in this precondition field serve as a precondition that effects a transition to the message sequence chart specified in the corresponding MSC name field. For example, the topmost record of the precondition table 131b denotes that a transition to message sequence chart MSC#A will be made when the expression “Full or Gating or Suspend” evaluates to true, i.e., when either of the scenarios “Full,” “Gating,” and “Suspend” is taken.

### (g) Process Flow of Design Verification Apparatus

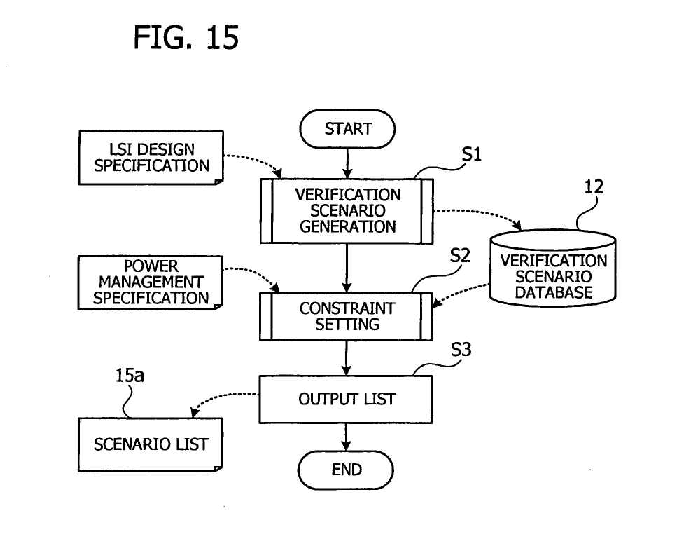

Referring to the flowchart of FIG. 15, the following will give a general process flow of the design verification apparatus.

At the outset, the verification scenario generating module 11 executes a verification scenario generation process on the basis of an LSI design specification 20 specified by the user, thus producing verification scenarios (step S1). The produced are saved in a verification scenario database 12. Subsequently the condition setting module 13 executes a constraint setting process based on a power management specification specified by the user. This constraint setting process places constraint conditions on the verification scenarios stored in the verification scenario database 12 (step S2). The resulting power management verification scenarios are stored in a power management verification scenario database 14. Then the output module 15 produces a scenario list 15a (step S3).

The design verification apparatus 10 basically follows the above process flow. Optionally, the above series of steps may include some interaction with the user. For example, the verification scenario generating module 11 may generate verification scenarios beforehand and save the result in the verification scenario database 12. The design verification apparatus 10 then waits for entry of a power management specification from the user before starting a constraint setting process. Or alternatively, the verification scenario generating module 11 may start generating verification scenarios when the user specifies a power management specification.

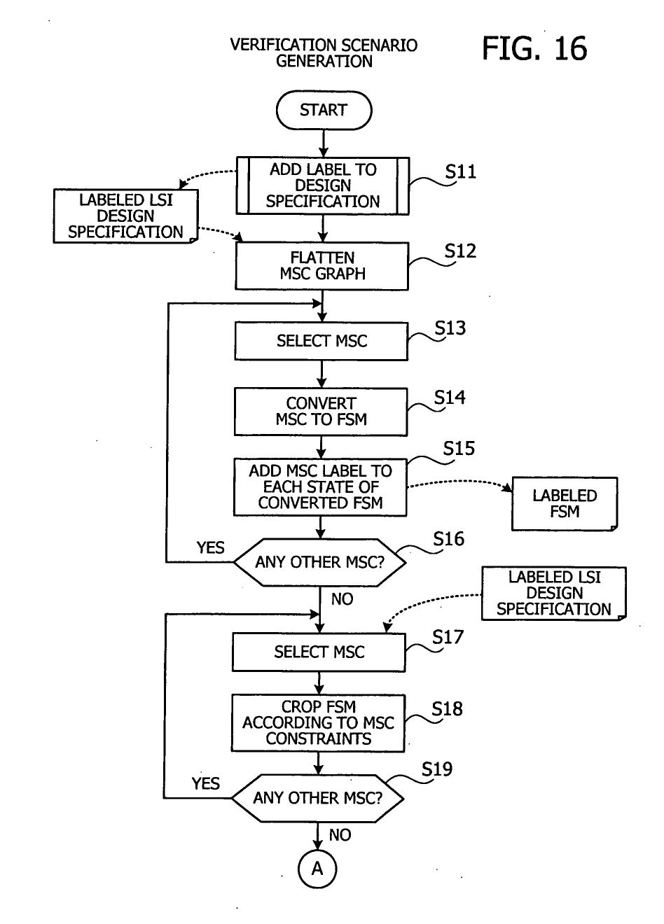

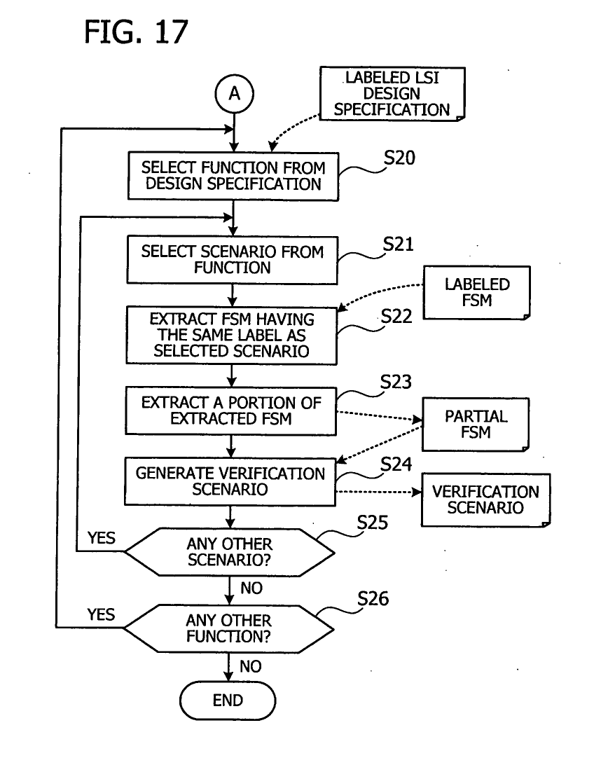

FIGS. 16 and 17 provide a flowchart of the verification scenario generation process called at step S1. This process proceeds as follows:

The verification scenario generation process first calls another process to add labels to the LSI design specification 20 (step S11). Details of this labeling process will be described later with reference to another flowchart. The process then flattens a directed graph of the labeled LSI design specification produced at step S11 (step S12). Out of the flattened directed graph, the process selects one message sequence chart (MSC) (step S13) and converts the selected message sequence chart into a finite state machine (FSM) (step S14). As a result of this step S14, data event messages exchanged in a series of message sequence charts are expressed as a finite state machine, as will be described in detail later.

The process adds a label to each state of the finite state machine (step S15). This label is what the currently selected message sequence chart has gained at step S11. As a result of steps S14 and S15, the finite state machine has obtained labels with each of its states. The verification scenario generating module 11 saves this labeled version of the finite state machine in its local temporary memory.

It is then determined whether there is any other message sequence chart that awaits processing (step S16). If there is such a remaining message sequence chart (Yes at step S16), the process returns to step S13 to select it and executes subsequent steps S14 and S15 with that newly selected message sequence chart. If no remaining message sequence charts are found (No at step S16), the process consults the labeled design specification saved in step S11 and selects therefrom one message sequence chart (step S17).

The selected message sequence chart may contain some constraints (e.g., synch, timeout). According to such constraints, the process crops the finite state machine by removing unnecessary states from the selected message sequence chart (step S18). Details of this step will be described later.

It is then determined whether there is any other message sequence chart that awaits processing (step S19). If such a message sequence chart is found (Yes at step S19), the process returns to step S17 to select it and executes subsequent step S18 with that newly selected message sequence chart. If there are no remaining message sequence charts (No at step S19), the process selects a function out of those defined in the labeled LSI design specification 20 (step S20 in FIG. 17).

The process then selects a scenario from the selected function (step S21) and extracts, from the labeled finite state machines produced at step S15, a finite state machine having the same label as the selected scenario (step S22). The process further extracts a portion of the finite state machine extracted at step S22, which is referred to as a “partial finite state machine” (step S23). The verification scenario generating module 11 saves the extracted partial finite state machine in its temporary memory. The process then generates a verification scenario from the partial finite state machine of step S23 and enters it to the verification scenario database 12 (step S24), as will be described in detail later.

It is determined whether there remains any other scenario in the function selected at step S20 (step S25). If another scenario is found (Yes at step S25), the process returns to step S21 to select it and executes subsequent steps S22 to S24 with that newly selected scenario. If there are no remaining scenarios in the function selected at step S20 (No at step S25), then the process determines whether the LSI design specification 20 has any other function that awaits processing (step S26). If such a remaining function is found (Yes at step S26), the process returns to step S20 to select it and executes subsequent steps S21 to S25 with that newly selected function. If there are no remaining functions (No at step S26), the verification scenario generation process terminates itself.

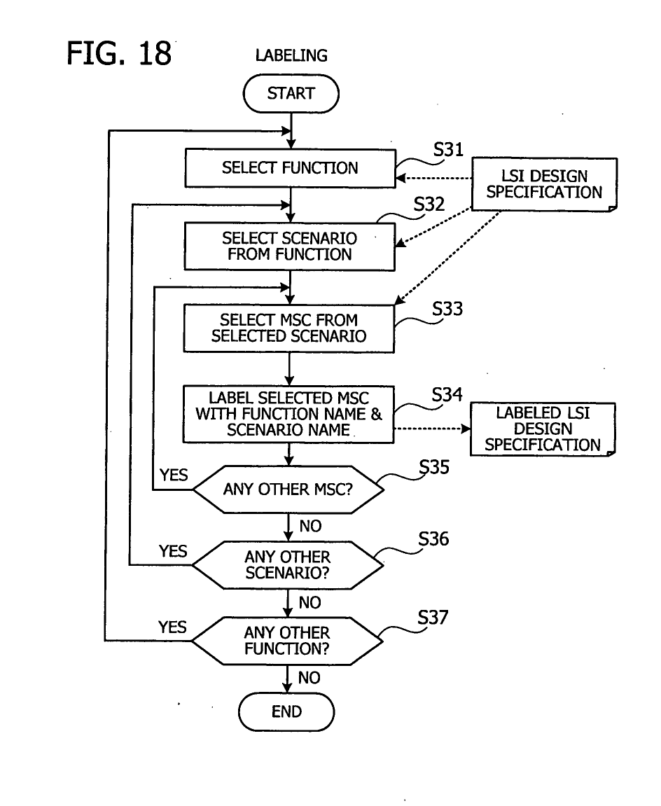

FIG. 18 is a flowchart of the labeling process executed at step S11 (FIG. 14). This labeling process proceeds as follows:

The labeling process first selects a function from those defined in a given LSI design specification 20 (step S31) and then selects a scenario out of the selected function (step S32). The labeling process further selects a message sequence chart in the selected scenario (step S33) and adds a label to this message sequence chart (step S34), which includes the function name of the currently selected function (i.e., the one selected at step S31) and the scenario name of the currently selected scenario (i.e., the one selected at step S32). In the case where the message sequence chart has an existing label, that label is updated with the additional label. The label may also include a message sequence chart name, in addition to the above-noted function name and scenario name.

The process now looks into the currently selected scenario to determine whether there remains any other message sequence chart that awaits processing (step S35). If such a message sequence chart is found in the scenario (Yes at step S35), the process returns to step S33 to select it and executes subsequent step S34 with the newly selected message sequence chart. If there are no remaining scenarios (No at step S35), then the process determines whether there is any other scenario that awaits processing (step S36). If such a scenario is found (Yes at step S36), the process returns to step S32 to select it and executes subsequent steps S33 to S35 with that newly selected scenario.

If no remaining scenarios are found (No at step S36), then the process determines whether there is any other function that awaits processing (step S37). If such a function is found (Yes at step S37), the process returns to step S31 to select it and executes subsequent steps S32 to S36 with that newly selected function. If there are no remaining functions (No at step S26), the verification scenario generation process terminates itself.

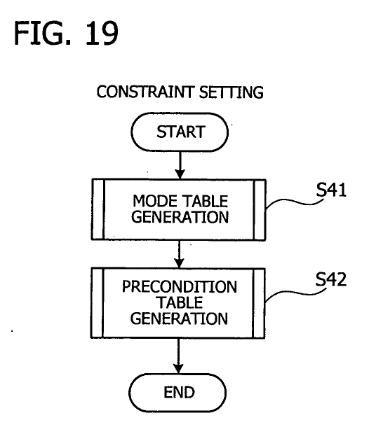

FIG. 19 is a flowchart of the constraint setting process called at step S2 of FIG. 15. This process proceeds as follows:

The condition setting module 13 first executes a mode table generation process to produce a mode table 131a (step S41). The condition setting module 13 then executes a precondition table generation process to produce a precondition table 131b (step S42). Based on this precondition table 131b, the condition setting module 13 places constraint conditions on the verification scenarios and subsequently terminates the constraint setting process.

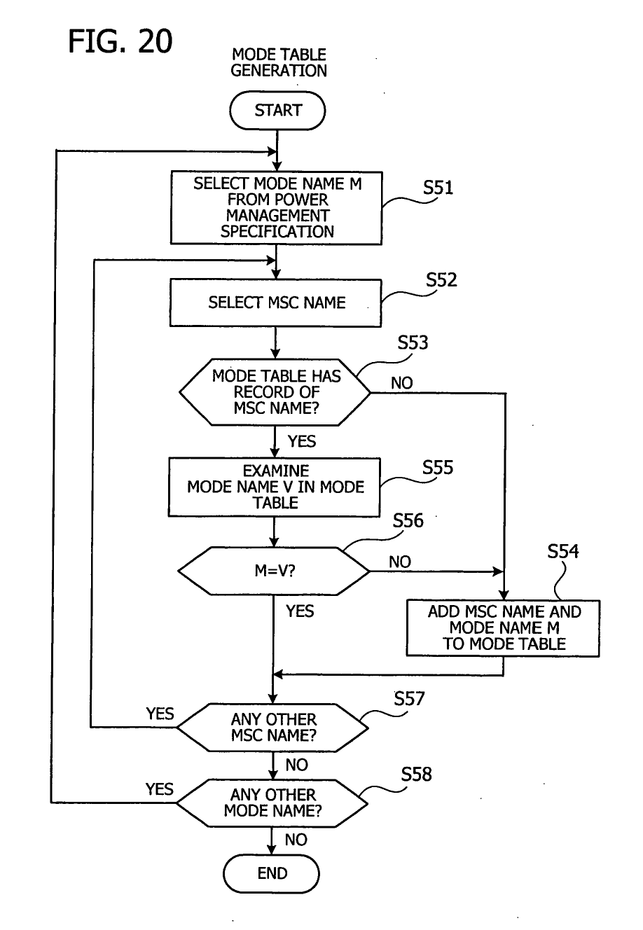

FIG. 20 is a flowchart of the mode table generation process called at step S41 of FIG. 19. This process proceeds as follows:

The condition setting module 13 first selects a mode name M from among those specified in the given power management specification (step S51), where M is a parameter representing a mode name. The condition setting module 13 then selects an MSC name under the mode name M in the power management specification and follows the link found in the message sequence chart having that MSC name, thus obtaining the MSC name of its linked message sequence chart (step S52). It is then determined whether the mode table 131a has any record that matches with the obtained MSC name (step S53). If the mode table 131a has no such records (No at step S53), the condition setting module 13 adds to the mode table 131a a new record including the obtained MSC name and mode name M (step S54) and moves to step S57. If the obtained MSC name is found in an existing record of the mode table 131a (Yes at step S53), the condition setting module 13 checks the mode name V associated with that MSC name in that record (step S55), where V is a parameter representing a mode name. It is then determined whether the two mode names M and V coincide with each other (step S56). If M is different from V (No at step S56), the process proceeds to step S54 and executes the subsequent steps. If M equals V (Yes at step S56), it is determined whether there is any other message sequence chart under the mode name M selected at step S51 (step S57). This step S57 is also executed next to step S54.

If another message sequence chart is found (Yes at step S57), the process returns to step S52 to select its MSC name and executes subsequent steps S53 to S56 with that newly selected MSC name. If there are no remaining message sequence charts under the mode name M (No at step S57), it is then determined whether the power management specification has any other remaining mode names (step S58). If another mode name is found in the power management specification (Yes at step S58), the process returns to step S51 to select it as a new value of M and executes steps S52 to S57 with that mode name M. If the power management specification has no remaining mode names (No at step S58), then the mode table generation process terminates itself.

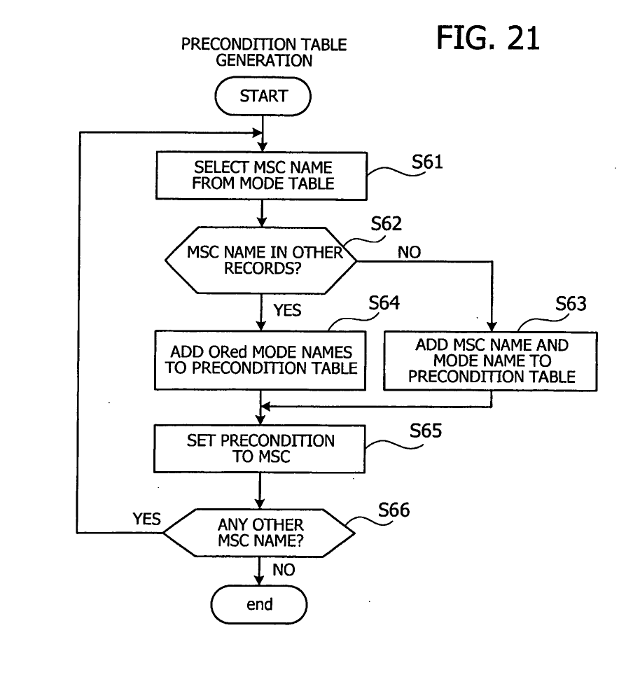

FIG. 21 is a flowchart of the precondition table generation process called at step S42 of FIG. 19. This process proceeds as follows:

The precondition table generation process first selects one MSC name from among those in the mode table 131a (step S61). It is then determined whether the mode table 131a has other records that match with the selected MSC name (step S62). If the mode table 131a has no match (No at step S62), the selected MSC name is added to the MSC name field of the precondition table 131b, and its corresponding mode name is placed in the precondition field of the same (step S63). The process then advances to step S65.

If the mode table 131a has other records that match with the selected MSC name (Yes at step S62), the selected MSC name is added to the MSC name field of the precondition table 131b. The mode names in all those records (including the one from which the current MSC name has been selected) are joined to each other by using “or” operator before they are added to the precondition field of the precondition table 131b (step S64). The precondition added at step S63 or S64 is then set to message sequence charts of relevant verification scenarios (step S65). This means that some preconditions specified in the power management specification have been reflected in the message sequence charts of relevant verification scenarios.

It is now determined whether there remains any other MSC name in the mode table 131a (step S66). If another MSC name is found in the mode table 131a (Yes at step S66), the process returns to step S61 to select it and executes steps S62 to S65 with the newly selected MSC name. If the mode table 131a has no remaining MSC names (No at step S66), then the precondition table generation process terminates itself.

### (h) Example of Labeling Process

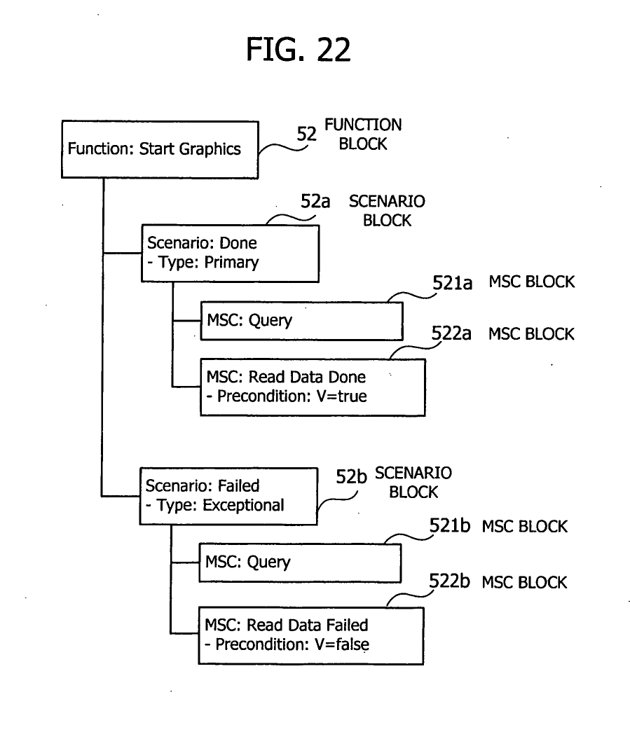

This section describes a specific example of the labeling process discussed in FIG. 18. FIG. 22 illustrates an example data structure of an LSI design specification. The illustrated LSI design specification 20 describes a function of graphics operation (simply “Graphics” in FIG. 22). Specifically, this design specification offers a simplified description of graphics operation invoked by an activation request from CPU to graphics accelerator.

More specifically, the LSI design specification of FIG. 22 has a function block 52 to represent a function that starts a graphics operation according to the following two scenarios. The first scenario activates the graphics accelerator and receives an operation completion notice therefrom. This first scenario is associated with a function presented in a function block 52, a processing scenario presented in a scenario block 52a, and a path for starting and executing a verification scenario to realize that processing scenario of the scenario block 52a. The verification scenario is implemented by using message sequence charts represented by MSC blocks 521a and 522a. The latter MSC block 522a contains an expression “V=true” as a precondition of its corresponding message sequence chart.

The second scenario similarly activates the graphics accelerator, but ends up with receiving an error message. This second scenario is associated with a function presented in a function block 52, a processing scenario presented in a scenario block 52b, and a path for starting and executing a verification scenario to realize that processing scenario of the scenario block 52b. The verification scenario is implemented by using message sequence charts represented by MSC blocks 521b and 522b. The latter MSC block 522b contains an expression “V=false” as a precondition of its corresponding message sequence chart. The following description refers to the above first scenario as scenario “Done” and the second scenario as scenario “Failed.”

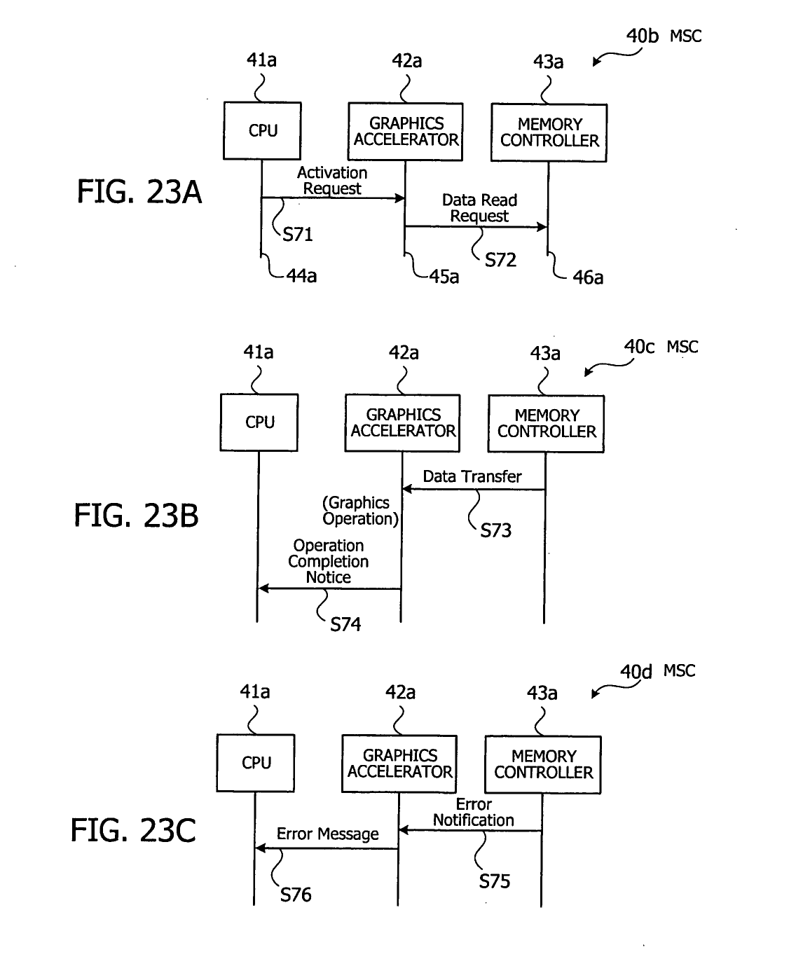

FIGS. 23A to 23C illustrate examples of message sequence charts involved in the above-noted verification scenarios. Referring first to FIG. 23A, a message sequence chart 40b corresponding to the MSC block 521a is depicted. This message sequence chart 40b is also referred to by the MSC name of “Query” as indicated in the MSC block 521a. FIG. 23A illustrates the following objects as part of the LSI circuit defined by the LSI design specification 20: CPU 41a, graphics accelerator (GA) 42a, and memory controller 43a. These three objects have their respective object lines, i.e., CPU line 44a, graphics accelerator line 45a, and memory controller line 46a.

Based on the foregoing rules, the message sequence chart 40b gives the following process: The CPU 41a sends an activation request to the graphics accelerator 42a (step S71). Upon receipt of this activation request, the graphics accelerator 42a sends a data read request to the memory controller 43a (step S72).

Referring now to FIG. 23B, a message sequence chart 40c corresponding to another MSC block 522a is depicted. This message sequence chart 40c is referred to by the MSC name of “Data read Done” as indicated in the MSC block 522a. The message sequence chart 40c contains the same objects as other similar message sequence charts involving the CPU 41a, graphics accelerator 42a, and memory controller 43a.

Based on the foregoing rules, the message sequence chart 40c gives the following process: Upon receipt of a data read request, the memory controller 43a transfers the requested data back to the graphics accelerator 42a (step S73), which permits the graphics accelerator 42a to execute a graphics operation using the received data. Upon completion of the operation, the graphics accelerator 42a sends an operation completion notice to the CPU 41a (step S74).

Referring then to FIG. 23C, a message sequence chart 40d corresponding to yet another MSC block 522b is depicted. This message sequence chart 40d is referred to by the MSC name of “Read Data Failed” as indicated in the MSC block 522b. The message sequence chart 40d contains the same objects as other similar message sequence charts involving the CPU 41a, graphics accelerator 42a, and memory controller 43a.

Based on the foregoing rules, the message sequence chart 40d gives the following process: The memory controller 43a returns an error to the graphics accelerator 42a (step S75). Upon receipt of this error, the graphics accelerator 42a sends an error message to the CPU 41a (step S76).

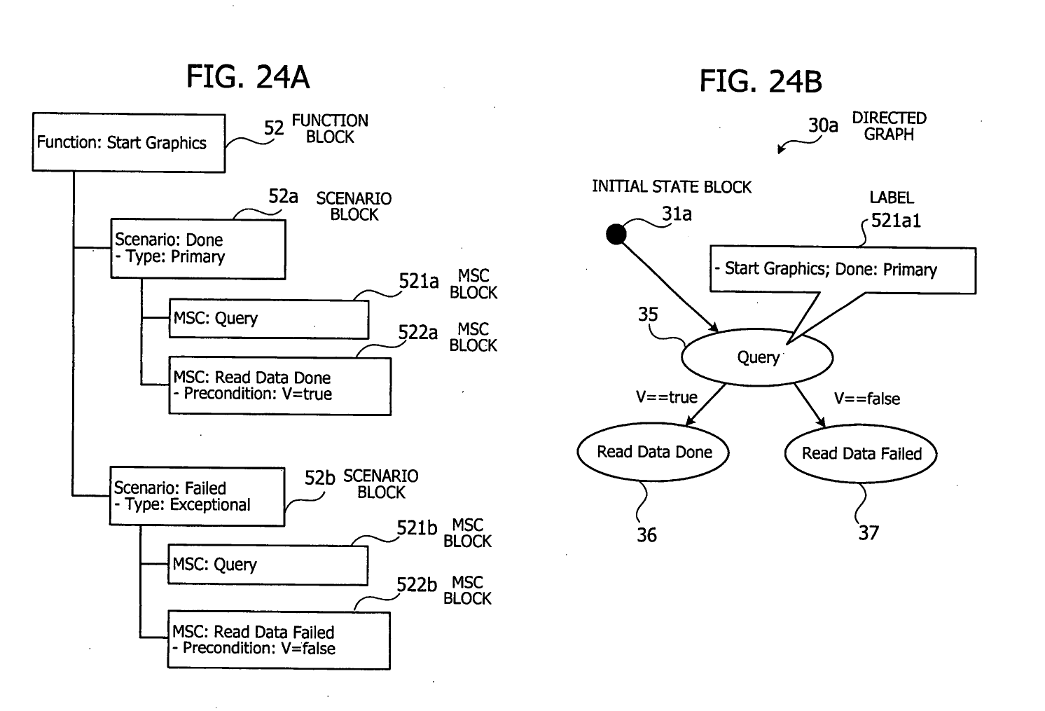

FIGS. 24A, 24B, 25A, 25B, 26A, and 26B provide an example of how labels are added to an LSI design specification. The illustrated directed graph 30a is formed from an initial state block 31a and three message sequence charts 35, 36, and 37 identified by MSC names of “Query,” “Read Data Done,” and “Read Data Failed,” respectively.

The labeling process first consults the LSI design specification 20 and selects function “Start Graphics” given in its function block 52. Out of the selected function, the process then selects scenario “Done” of the scenario block 52a. The process now selects a message sequence chart 35 named “Query,” one of the two message sequence charts of the selected scenario “Done.”

The selected message sequence chart 35 will now be labeled as follows. As described earlier, labels are supposed to include the names of the currently selected function and scenario in the form of “function name; scenario name: scenario type.” Accordingly, in the present example, the message sequence chart 35 is added a label 521a1 which reads “Start Graphics; Done: Primary.” This is what is seen in FIGS. 24A and 24B.

The process then determines whether there remains any other message sequence chart in the present scenario block 52a, and thus discovers and selects another message sequence chart 36 named “Read Data Done.” The selected message sequence chart 36 is added a label 522a1 which reads “Start Graphics; Done: Primary.”

The labeling process determines again whether there remains any other message sequence chart in the scenario block 52a. As this test returns a negative result, the process goes back to the function block 52 to see whether there is any other scenario. The process thus discovers and selects another scenario “Failed” of scenario block 52b.

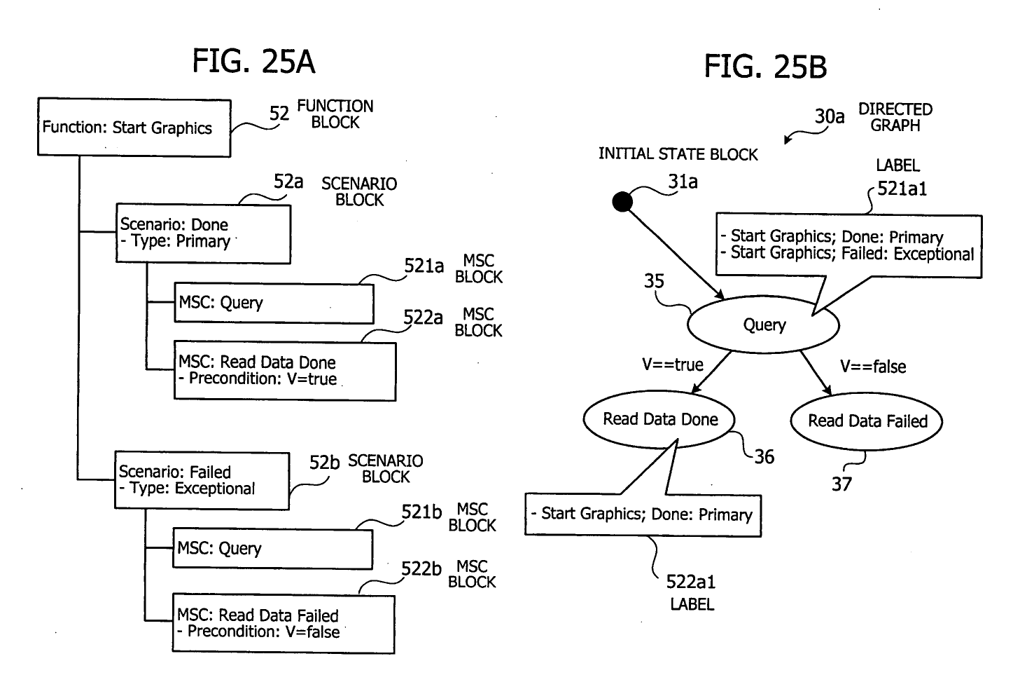

The process now selects a message sequence chart named “Query,” one of the two message sequence charts of the newly selected scenario “Failed.” This message sequence chart “Query” gains a label that reads “Start Graphics; Failed: Exceptional.” Since the message sequence chart “Query” already has a label 521a1, the labeling process updates that label 521a1 with an additional line of “Start Graphics; Failed: Exceptional.” FIGS. 25A and 25B depict the processing results up to this point.

The process then determines whether there remains any other message sequence chart in the present scenario block 52b, and thus discovers and selects another message sequence chart 37 named “Read Data Failed.” This message sequence chart 37 gains a label 522b1 that reads “Start Graphics; Failed: Exceptional.”

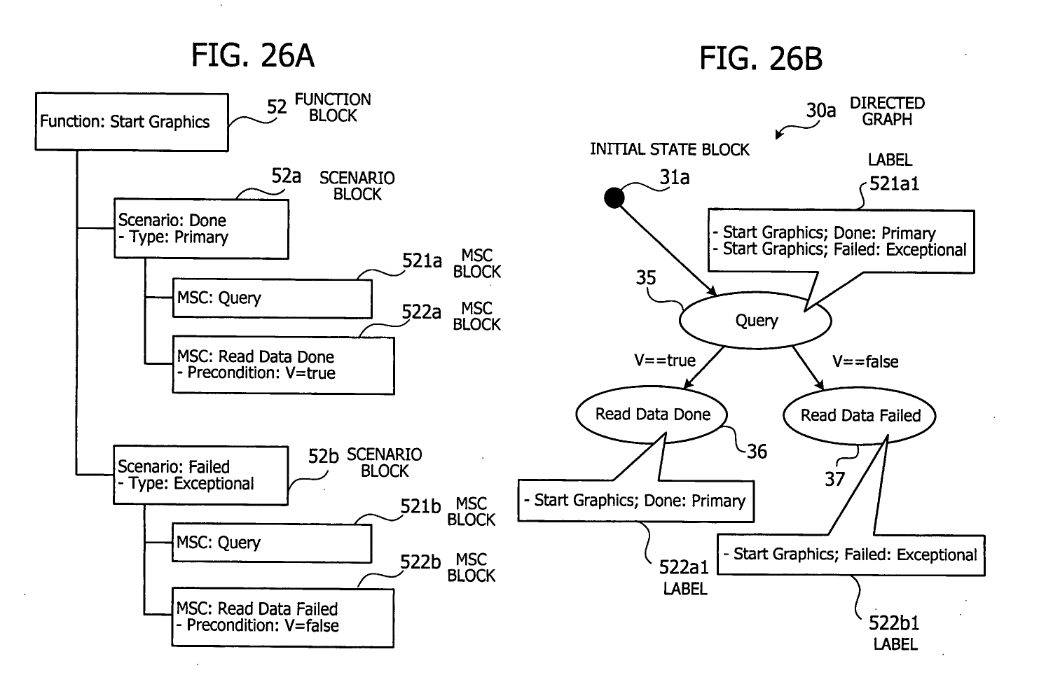

The labeling process determines again whether there remains any other message sequence chart in the scenario block 52b. This test returns a negative result. The labeling process determines whether there remains any other scenario in the function block 52. As this test also returns a negative result, the process terminates itself accordingly. FIGS. 26A and 26B depict the processing results up to this point.

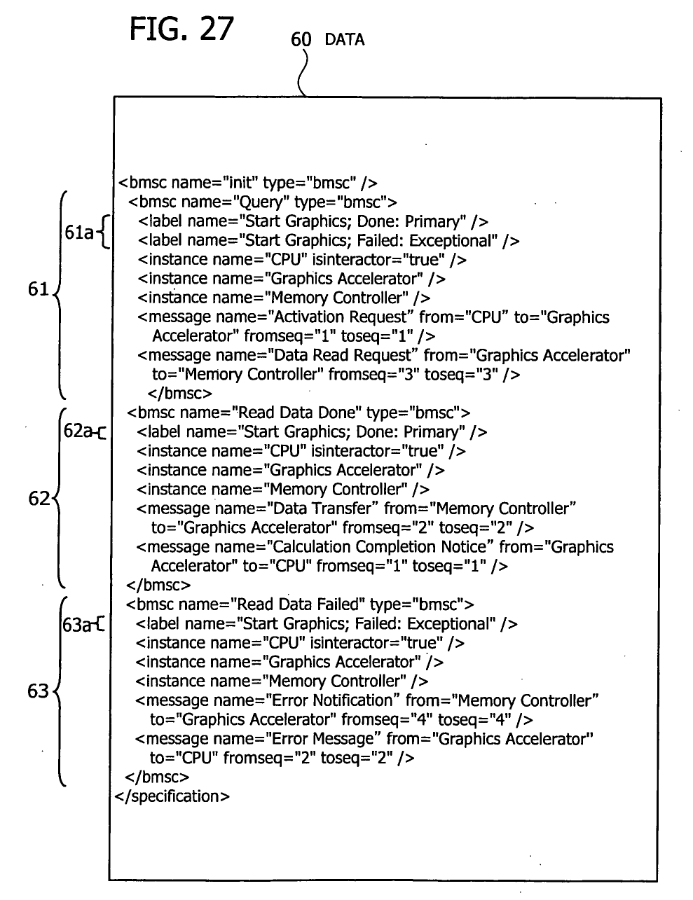

FIG. 27 illustrates an example data structure of a labeled LSI design specification. The illustrated data describes a labeled version of the LSI design specification 20 in the XML format. This data 60 is formed from three parts of descriptions 61, 62, and 63. The first description 61 describes the message sequence chart 40b discussed in FIG. 23A. The second description 62 describes the message sequence chart 40c discussed in FIG. 23B. The third description 63 describes the message sequence chart 40d discussed in FIG. 20C.

The descriptions 61, 62, and 63 include new lines 61a, 62a, and 63a, respectively, which have been added by the foregoing labeling process, as indicated by the XML tag <label name>. The contents of each tag derive from the labels added to the finite state machine. As mentioned earlier, these labels may optionally contain the name of a message sequence chart, in addition to what is given in the form of “function name; scenario name: scenario type.”

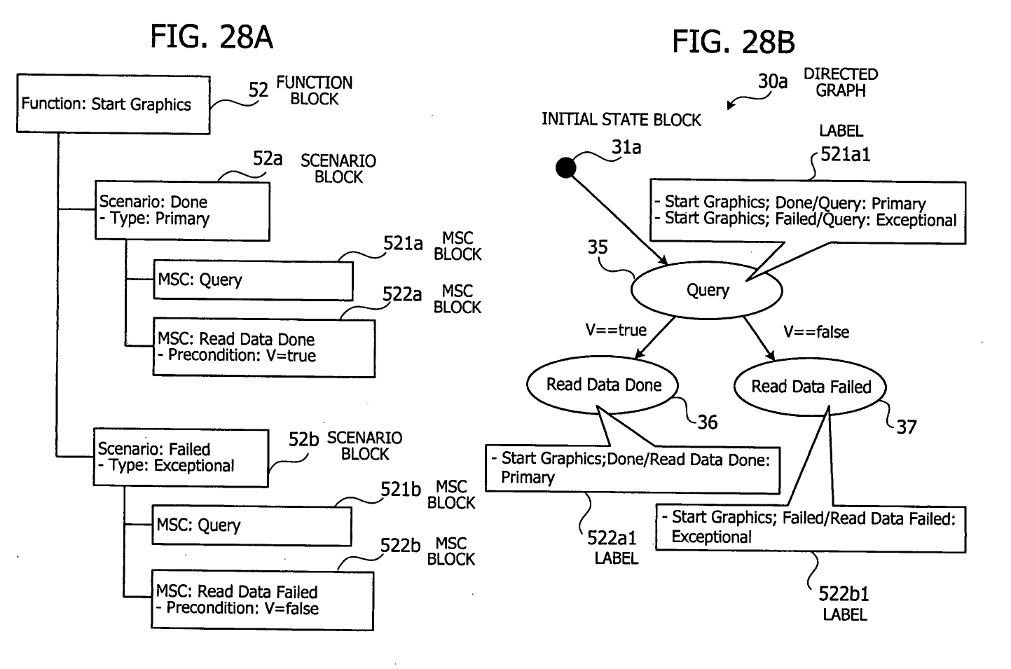

FIGS. 28A and 28B provide another example of how labels are added to an LSI design specification. Specifically, the illustrated labels 521a1, 522a1, and 522b1 contain the name of a corresponding message sequence chart in addition to the function name, scenario name, and scenario type.

### (i) Finite State Machine Generation

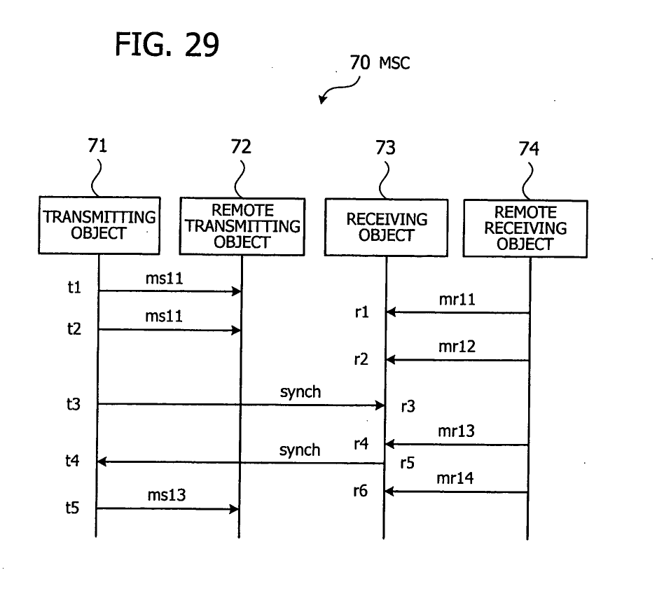

Referring now to FIGS. 29 to 31, this section describes a specific example of step S14 (FIG. 16) which converts a message sequence chart into a finite state machine. FIG. 29 is a message sequence chart which is subjected to such a conversion process. To turn a directed graph into a finite state machine, the process of step S14 determines each state of the finite state machine by using events defined in each message sequence chart that the directed graph provides. Here, a message sequence chart defines the order of possible events, and each completed event of an object corresponds to a state of the finite state machine. The initial state, for example, corresponds to an event that is never completed in any objects. The final state, on the other hand, corresponds to all events that have been completed in the objects.

Referring to the message sequence chart 70 of FIG. 29, each part of this chart will be reflected in the target finite state machine through a collection of events that occur to a part of the objects. Specifically, the objects illustrated in FIG. 29 are: a transmitting object 71, a remote transmitting object 72, a receiving object 73, and a remote receiving object 74. For example, one finite state machine is generated from the transmitting object 71 and receiving object 73. As can be seen in FIG. 29, the transmitting object 71 has five transmit events t1 to t5, while the receiving object 73 has six receive events r1 to r6. Here the transmitting object 71 is associated with the receiving object 73 by two synchronization edges (synch), without actually exchanging messages.

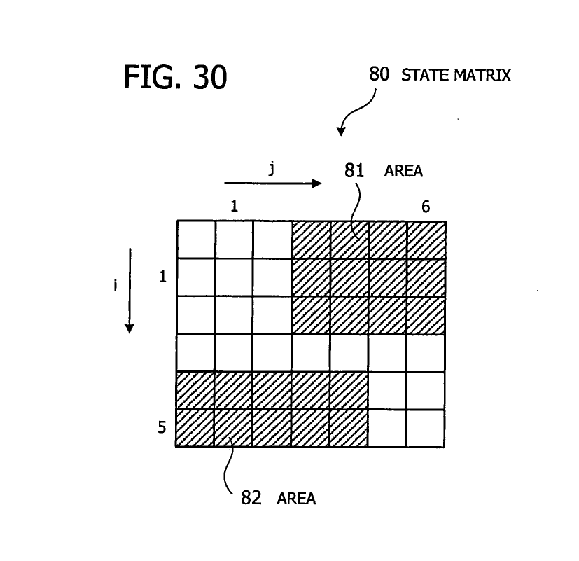

FIG. 30 illustrates a state matrix corresponding to the message sequence chart of FIG. 29. This state matrix 80 will be used to further explain how to generate a finite state machine. For illustrative purposes, it is assumed that there are only two objects 71 and 73 in the message sequence chart 70. This assumption permits the finite state machine to be visualized as a two-dimensional state matrix 80. Each block of this state matrix 80 represents a particular state in which the transmitting object 71 has completed a transmit event ti and the receiving object 73 has completed a receive event rj. In other words, block (i, j) represents state (ti, rj).

The state matrix 80 has its origin at the top-left corner, and the inverted-T symbol “⊥” is used to indicate initial state. Departing the initial state at the top-left corner, state transitions take place in the direction toward the bottom-right corner representing the final state.

If the transmitting object 71 and receiving object 73 had no synchronization edges between them, their state matrix 80 would be a fully-populated n×m state matrix, where n is the number of messages transmitted from the transmitting object 71, and m is the number of messages received by the receiving object 73. The presence of synchronization edges in the message sequence chart 70, however, reduces the number of effective states in the corresponding state matrix 80. That is, a synchronization edge nullifies some states in the state matrix 80, and it is thus possible to cross out such ineffective states.

Transmit event t3, for example, corresponds to a synchronization edge extending from the transmitting object 71 to the receiving object 73. Reception event r3 is associated with that synchronization edge in this case. This means that every event occurring at the receiving object 73 after the receive event r2 should not precede the transmit event t3. Accordingly, receive events r3 to r6 are not allowed to happen before the transmit event t3. Based on this fact of the objects 71 and 73, the finite state machine generation process crosses out an ineffective area 81 of the state matrix 80. Another ineffective area 82 corresponding to the second synchronization edge in the message sequence chart 70 is crossed out similarly.

The remaining areas of the state matrix 80 fully represent the message sequence chart 70. For example, state t2 refers to a state of the transmitting object 71 when it has finished transmit event t2. State r1 refers to a state of the receiving object 73 when it has finished receive event r1.

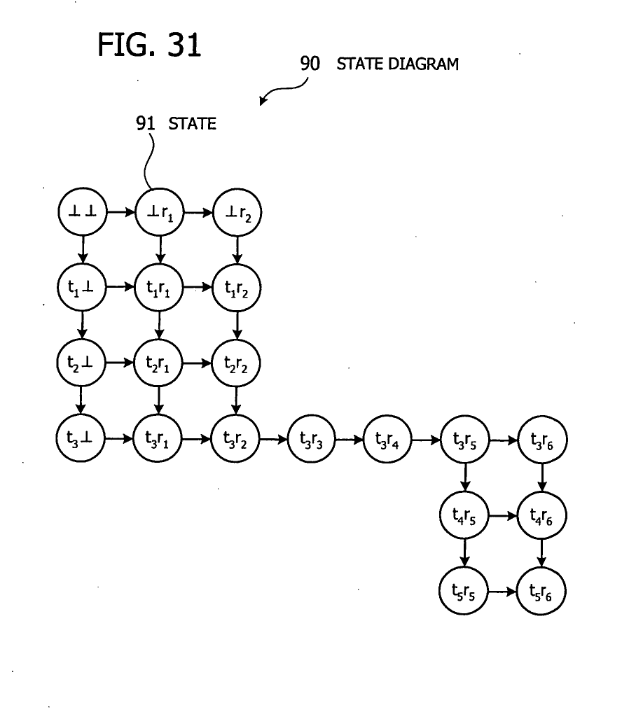

FIG. 31 is a state diagram corresponding to the state matrix 80 discussed above. State 91 is one of the states in the illustrated state diagram 90. This state 91 corresponds to one block of the state matrix 80 of FIG. 30. Each symbol of state (i.e., circles in FIG. 31) contains a specific state value. In the illustrated state diagram 90, a state transition in the horizontal direction corresponds to reception of a message. This is implemented in a finite state machine as transmission of a message. Likewise, a state transition in the vertical direction corresponds to transmission of a message. This is implemented in a finite state machine as a state awaiting a message.

When it is possible to move from the current state (i, j) to a new state in either of the horizontal and vertical directions, a horizontal transition is fired by transmitting a message. It is subsequently determined whether a message invoking a vertical transition has been received. If that test result is positive, a vertical transition may also take place, in which case the next state will be (i+1, j+1). If the test result is negative, the transition will only happen in the horizontal direction, from (i, j) to (1+1, j).

A timer is employed for an object awaiting a message in order not to let the object wait endlessly. This timer terminates the waiting state upon expiration of an appropriate time. Some states may allow either a vertical transition or a horizontal transition, but not both. For such states, the finite state machine only implements their applicable transitions.

As can be seen from the above, the direction of transition is one of the parameters that affect generation of finite state machines. Another such parameter is a particular type of events related to the state. Take a transmitting object 71 and a receiving object 73 in FIG. 29, for example. This transmitting object 71 has several events on its object line, each of which falls in one of the following three categories: message transmit events, timer start events, and timeout signal receive events. Similarly, the receiving object 73 has several events which fall in one of the following three categories: message receive events, timer start events, and timeout signal receive events. These variations of event types in each object lead to nine possible combinations of states which should be considered when generating a finite state machine, since the code produced for each node of the machine depends on the exact combinations of such states.

With the above-described techniques, finite state machines are generated from given message sequence charts. Specifically, to produce finite state machines corresponding to different scenarios, the generation process traces the path of each scenario and generates a finite state machine for each message sequence chart encountered on the path. The final state of one message sequence chart is linked to the first state of the next message sequence chart on the path. If necessary, the resulting finite state machines may be combined into a single machine.

Finite state machines may be generated and edited automatically by combining signals and variable declarations. The resulting finite state machines can then be used to simulate the operation of the device 300 under test (FIG. 4).

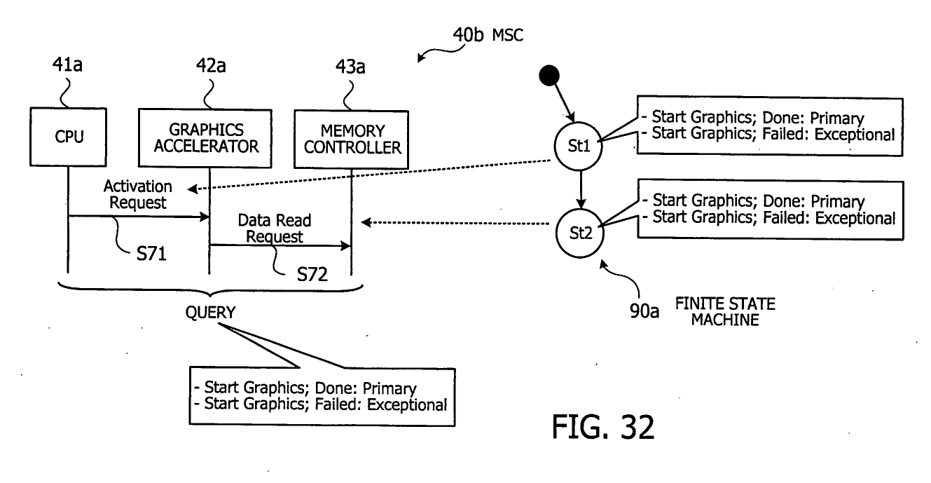

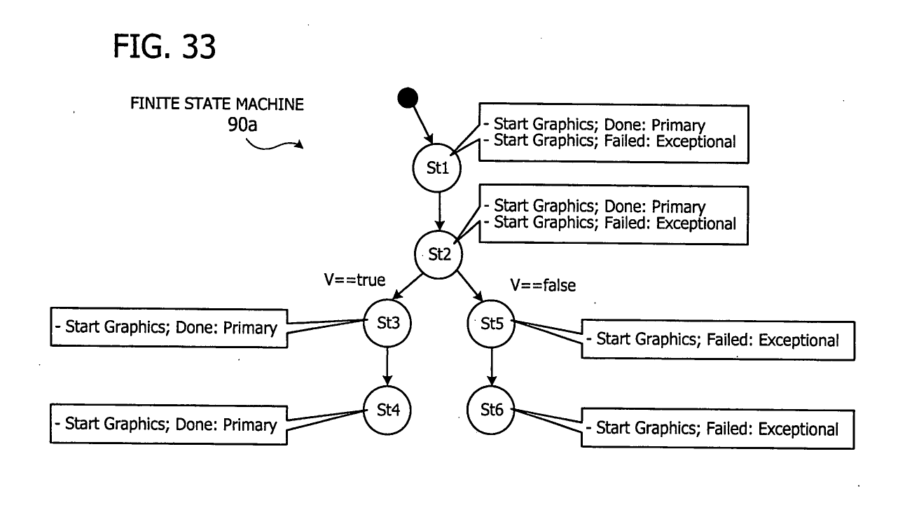

Referring now to the flowchart of FIGS. 32 and 33, a specific example of the labeling process of step S15 (FIG. 16) will be described. FIG. 32 gives an example of how labels are added to a finite state machine. Specifically, FIG. 32 illustrates a finite state machine 90a that is produced from a message sequence chart 40b by using the foregoing method. The labels of the source message sequence chart 40b are added to each state of this finite state machine 90a.

In the example of FIG. 32, the finite state machine 90a has two machine states St1 and St2 corresponding to the data event messages of the source message sequence chart “Query.” The message sequence chart “Query” bears the following two labels:

“Start Graphics; Done: Primary”

“Start Graphics; Failed: Exceptional”

Accordingly, these two labels are given to each of the two states St1 and St2.

FIG. 33 depicts a final view of the labeled finite state machine. As can be seen from FIG. 33, the finite state machine 90a has gained four additional machine states St3, St4, St5, and St6. The first two states St3 and St4 correspond to data event messages of another source message sequence chart “Read Data Done” while the second two states St5 and St6 correspond to data event messages of yet another source message sequence chart “Read Data Failed.” Since the former message sequence chart “Read Data Done” has a label of “Start Graphics; Done: Primary,” the same label is added to states St3 and St4 of the finite state machine 90a. Likewise, since the latter message sequence chart “Read Data Failed” has a label of “Start Graphics; Failed: Exceptional,” the same label is added to states St5 and St6 of the finite state machine 90a.

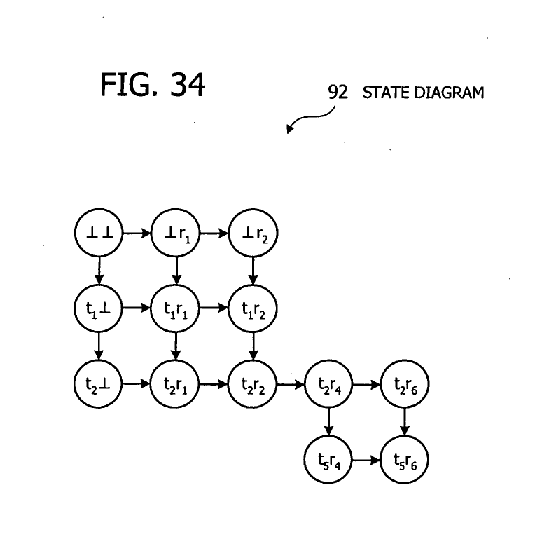

FIG. 34 is a state diagram corresponding to the foregoing state matrix. This diagram illustrates how the process of step S18 (FIG. 16) crops the finite state machine according to constraints of a given message sequence chart. That is, synchronization events may be removed from the state diagram 90 of FIG. 31 since they are only used to partly limit the order of actual operation events according to some constraint of other devices or external entities. Removal of such synchronization events yields a simplified state diagram 92 as depicted in FIG. 34.

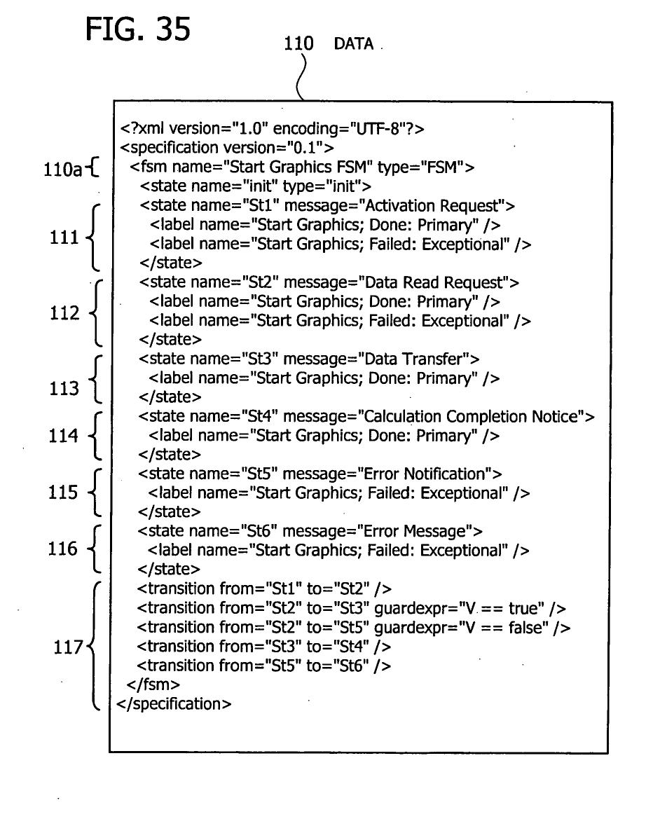

FIG. 35 illustrates an example data structure of a finite state machine. The illustrated data 110 describes a finite state machine in the XML format, which is formed from a plurality of descriptions 110a and 111 to 117. Description 110a gives an identifier of the finite state machine 90a (FIG. 33) in a finite state machine tag <fsm name>, which indicates that what is described in the data 110 is a finite state machine. The contents of each tag derive from the corresponding labels added to the finite state machine. More specifically, descriptions 111 to 116 correspond to states St1 to St6, respectively. Description 117 describes transitions among those states St1 to St6.

Referring now to the LSI design specification 20 of FIG. 22 and the labeled finite state machine 90a of FIG. 33, the following description will provide a specific example of how a verification scenario is generated from each processing scenario.

The verification scenario generation process first consults the design specification of FIG. 22 and selects a function “Start Graphics” of the function block 52. Out of the selected function, the process then selects a scenario “Done” and extracts a finite state machine that contains “Done” in its labels. Specifically, the finite state machine 90a of FIG. 33 is subjected to an extraction task to extract a portion bearing the same label as the selected scenario. As can be seen from FIG. 33, the selected scenario “Done” has a label of “Start Graphics; Done: Primary.” Accordingly, a collection of states St1 to St4 is extracted from the finite state machine 90a. The extracted partial finite state machine is then saved in the verification scenario database 12 as a verification scenario for the purpose of testing the selected processing scenario “Done” of the given design specification.

The process now determines whether there remains any other scenario in the selected function, thus finding another scenario “Failed.” Accordingly, the process selects that scenario “Failed” from the selected function “Start Graphics” and extracts a finite state machine that contains “Failed” in its labels. Specifically, the finite state machine 90a of FIG. 33 is subjected to an extraction task to extract a portion bearing the same label as the selected scenario. As can be seen from FIG. 33, the selected scenario “Failed” has a label of “Start Graphics; Failed: Exceptional.” Accordingly, a collection of states St1, St2, St5, and St6 is extracted from the finite state machine 90a. The extracted partial finite state machine is then saved in the verification scenario database 12 as a verification scenario for the purpose of testing the selected processing scenario “Failed” of the design specification.

The process determines again whether there remains any other scenario in the selected function, but finds no unselected scenarios. The process further determines whether there remains any other function in the design specification, but finds no remaining functions. Accordingly, the process terminates itself.

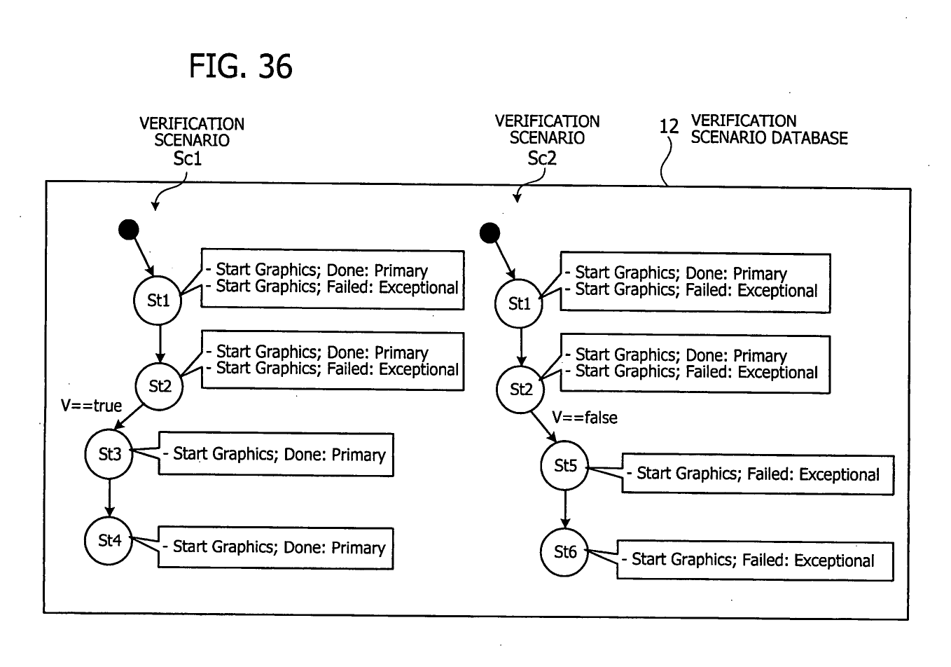

FIG. 36 illustrates verification scenarios stored in the verification scenario database 12. As can be seen in FIG. 36, there are two verification scenarios, Sc1 for testing a processing scenario “Done” and Sc2 for testing another processing scenario “Failed.”

### (j) Verification Scenario Generation

This section will provide more details of the above-described verification scenario generation, with a focus on how the process of step S24 (FIG. 17) produces a verification scenario from a given partial finite state machine.

As described in the preceding section, verification scenarios are produced from partial finite state machines. While the task was relatively straightforward in the foregoing examples, that is not always the case. For instance, the verification scenario generating module 11 may actually encounter a finite state machine containing a loop of states. In such a case, the verification scenario generating module 11 may need to cut or divide the given partial finite state machine into several units in order to generate verification scenarios.

For example, a partial finite state machine may be cut into smaller units according to the presence of a state that appears repetitively on the same path. Alternatively, or in addition to that, a plurality of verification scenarios may be produced according to the constraint that at least a minimum number of, or at most a maximum number of states be present in each verification scenario.

Suppose, for example, that the following partial finite state machine has been extracted from the original machine:
St2→St4→St6→St7→St2→St3→St6→St7→St2→St3→St5→St7→St2→St3→St5→St2.

One logic used to divide such a partial finite state machine is to cut the loop at a state that appears repetitively. In the present case, state St2 is where this long partial finite state machine will be cut into four verification scenarios as follows:

(1) St2→St4→St6→St7

(2) St2→St3→St6→St7

(3) St2→St3→St5→St7

(4) St2→St3→St5→St2

To produce a longer verification scenario, the verification scenario generating module 11 is allowed to enforce a requirement that at least five states be included in each verification scenario, in addition to the use of St2 as a cutting point. These constraints result in the following two verification scenarios:

(5) St2→St4→St6→St7→St2→St3→St6→St7

(6) St2→St3→St5→St7→St2→St3→St5→St2

### (k) Mode Conditions

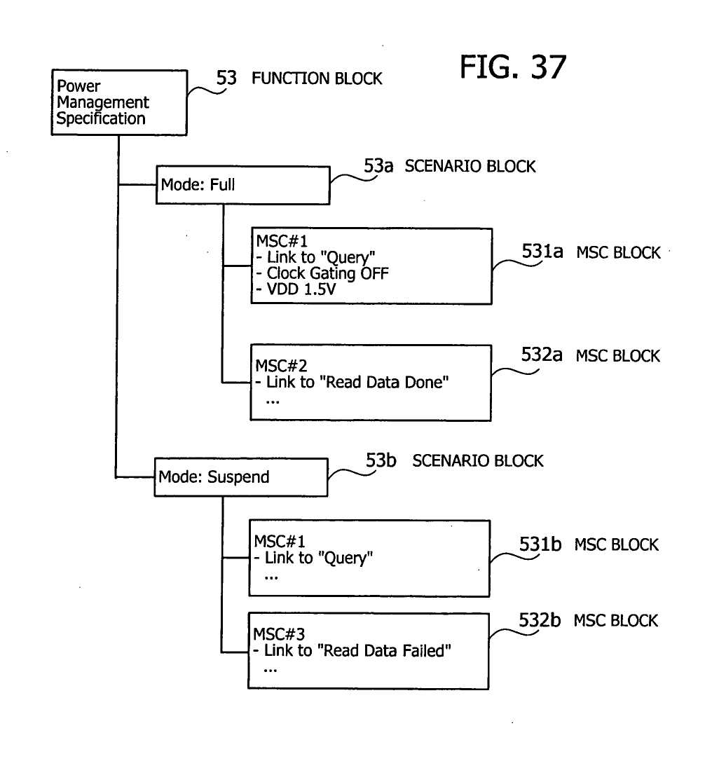

This section describes a more specific example of how a mode table 131a and a precondition table 131b are produced from a power management specification. FIG. 37 illustrates an example of a power management specification directed to graphics functions of the foregoing LSI design specification 20 of FIG. 22. Specifically, FIG. 37 illustrates a function block 53 representing a power management specification formed from two scenarios. That is, scenarios “Mode: Full” and “Mode: Suspend” are defined in scenario blocks 53a and 53b, respectively.

Scenario “Mode: Full” is realized by two message sequence charts named “MSC#1” and “MSC#2” in MSC blocks 531a and 532a, respectively. When the graphics function collects data successfully, this scenario “Mode: Full” initiates a transition to Full mode.

Scenario “Mode: Suspend” is realized by two message sequence charts named “MSC#1” and “MSC#3” in MSC blocks 531b and 532b, respectively. When the graphics function fails to collect data successfully, this scenario “Mode: Suspend” initiates a transition to Suspend mode.

Each message sequence chart of the power management specification has a link to a specific function defined in the LSI design specification 20. For example, message sequence chart MSC#1 is linked to message sequence chart “Query” in FIG. 22. Likewise, message sequence chart MSC#2 is linked to message sequence chart “Read Data Done” in FIG. 22, and message sequence chart MSC#3 is linked to message sequence chart “Read Data Failed” in FIG. 22. Each message sequence chart of the power management specification is also given a specific preconditions.

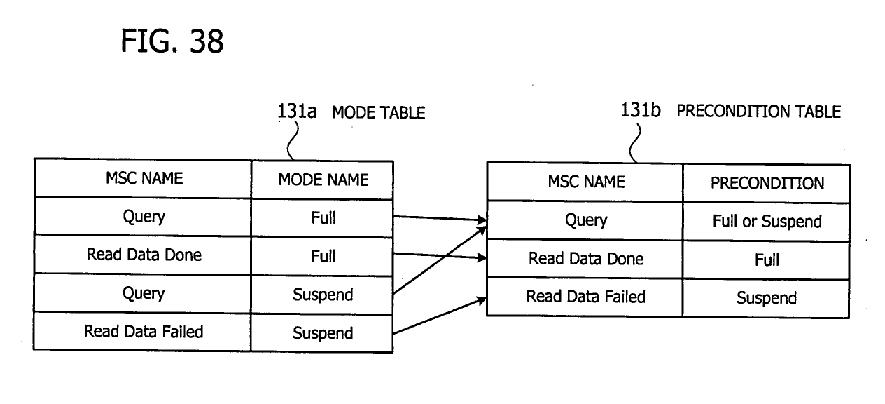

FIG. 38 illustrates an example of how to create a mode table and a precondition table. Initially the MSC name field and mode name field of this mode table 131a are both blank. The condition setting module 13 first selects a mode name “Full” from among those specified in the given power management specification. The condition setting module 13 then selects an MSC name “MSC#1” found under the selected mode name “Full” in the structure of the power management specification. The condition setting module 13 follows the link found in the message sequence chart MSC#1, thus obtaining the MSC name “Query” of its linked message sequence chart.

The condition setting module 13 then determines whether any record that matches with the obtained MSC name “Query” is present in the mode table 131a. Since no such records exist at present, the condition setting module 13 gives the mode table 131a a new record including the selected MSC name “Query” and mode name “Full.”

The condition setting module 13 determines whether there remains any other MSC under the selected mode name “Full” in the power management specification. Since another MSC name “MSC#2” is found, the condition setting module 13 selects it and follows the link in that message sequence chart MSC#2, thus obtaining the MSC name “Read Data Done” of its linked message sequence chart.

The condition setting module 13 then determines whether the mode table 131a has any record that matches with the obtained MSC name “Read Data Done.” Since no such records are found, the condition setting module 13 gives the mode table 131a a new record including the selected MSC name “Read Data Done” and mode name “Full.”

The condition setting module 13 determines whether there remains any other MSC under the selected mode name “Full.” Since no more MSC is present, the condition setting module 13 then determines whether there remains any other mode name in the power management specification. The condition setting module 13 now finds and selects another mode name “Suspend” in the power management specification. Then the condition setting module 13 selects an MSC name “MSC#1” found under the selected mode name “Suspend” and follows the link in the message sequence chart MSC#1, thus obtaining the MSC name “Query” of its linked message sequence chart.

The condition setting module 13 determines whether the mode table 131a has any record that matches with the obtained MSC name “Query.” Since the mode table 131a has a record having “Query” in its MSC name field, the condition setting module 13 looks into the corresponding mode name field, thus finding a mode name “Full” in that record. It is then determined whether the two mode names coincide with each other. Since the selected mode name “Suspend” is different from the current value “Full” of the record, the condition setting module 13 gives the mode table 131a a new record including the selected MSC name “Query” and mode name “Suspend.”

The condition setting module 13 determines whether there remains any other MSC under the selected mode name “Suspend.” The condition setting module 13 now finds and selects an MSC name “MSC#3” and follows the link in that message sequence chart MSC#3, thus obtaining the MSC name “Read Data Failed” of its linked message sequence chart.

The condition setting module 13 now determines whether any record that matches with the obtained MSC name “Read Data Failed” is present in the mode table 131a. Since no such records are found, the condition setting module 13 gives the mode table 131a a new record including the selected MSC name “Read Data Failed” and mode name “Suspend.”

The condition setting module 13 determines whether there remains any other MSC under the selected mode name “Suspend” in the power management specification. Since no more MSCs are present, the condition setting module 13 then determines whether there remains any other mode name in the power management specification. Since there are no more mode names, the condition setting module terminates the current process. The resulting mode table 131a is illustrated in the left half of FIG. 38.

The condition setting module 13 now produces a precondition table as follows. Initially the MSC name field and precondition field of the precondition table 131b are both blank. The condition setting module 13 selects an MSC name “Query” from among those in the mode table 131a. It is then determined whether the mode table 131a has other records that match with the selected MSC name. Since the mode table 131a has two such records, the condition setting module 13 adds the selected MSC name “Query” to the MSC name field of the precondition table 131b, and fills its corresponding precondition field with the mode names “Full” and “Suspend” joined by using “or” operator. Based on this precondition field value, the condition setting module 13 gives a precondition “Full or Suspend=true” to the message sequence chart 35 named “Query.” This means that some preconditions in the power management specification have been reflected in the message sequence charts of relevant verification scenarios.

The condition setting module 13 determines whether the mode table 131a has any other remaining MSC names, and thus finds and selects “Read Data Done” from the mode table 131a. It is then determined whether the mode table 131a has other records that match with the selected MSC name “Read Data Done.” Since this test returns a negative result, the condition setting module 13 adds the selected MSC name “Read Data Done” to the MSC name field of the precondition table 131b, together with its corresponding mode name “Full” in the precondition field of the same. Based on this precondition field value, the condition setting module 13 gives a precondition “Full=true” to the message sequence chart 36 named “Read Data Done.” The condition setting module 13 also gives another precondition “Suspend=false” to negate the Suspend mode.

The condition setting module 13 determines whether the mode table 131a has any other remaining MSC names, and thus finds and selects “Read Data Failed” from the mode table 131a. It is then determined whether the mode table 131a has other records that match with the selected MSC name “Read Data Failed.” Since this test returns a negative result, the condition setting module 13 adds the selected MSC name “Read Data Failed” to the MSC name field of the precondition table 131b, together with its corresponding mode name “Suspend” in its corresponding precondition field. Based on this precondition field value, the condition setting module 13 gives a precondition “Suspend=true” to the message sequence chart 37 named “Read Data Failed.” The condition setting module 13 also gives another precondition “Full=false” to negate the Full mode.

The condition setting module 13 determines whether the mode table 131a has any other remaining MSC names. Since there remain no other MSC names in the mode table 131a, the condition setting module 13 terminates the current process. The resulting precondition table 131b is illustrated in the right half of FIG. 38.

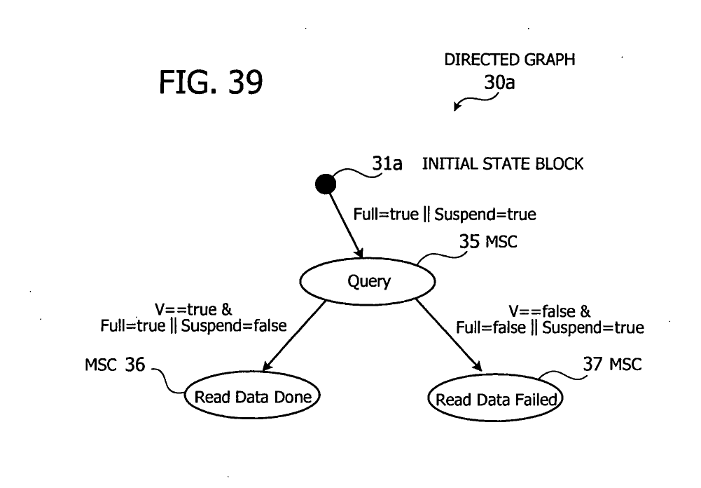

FIG. 39 illustrates a directed graph representing power management verification scenarios. The illustrated directed graph 30a is formed from an initial state block 31a and three message sequence charts 35, 36, and 37 identified by the MSC names of “Query,” “Read Data Done,” and “Read Data Failed,” respectively. According to one precondition seen in FIG. 39, a transition to the message sequence chart 36 occurs if the constraint condition of “V=true” and (“Full=true or Suspend=false”) evaluates to true when the message sequence chart 35 named “Query” is finished. According to another precondition seen if FIG. 39, a transition to the message sequence chart 37 occurs if the constraint condition of “V=false” and (“Full=false or Suspend=true”) evaluates to true.

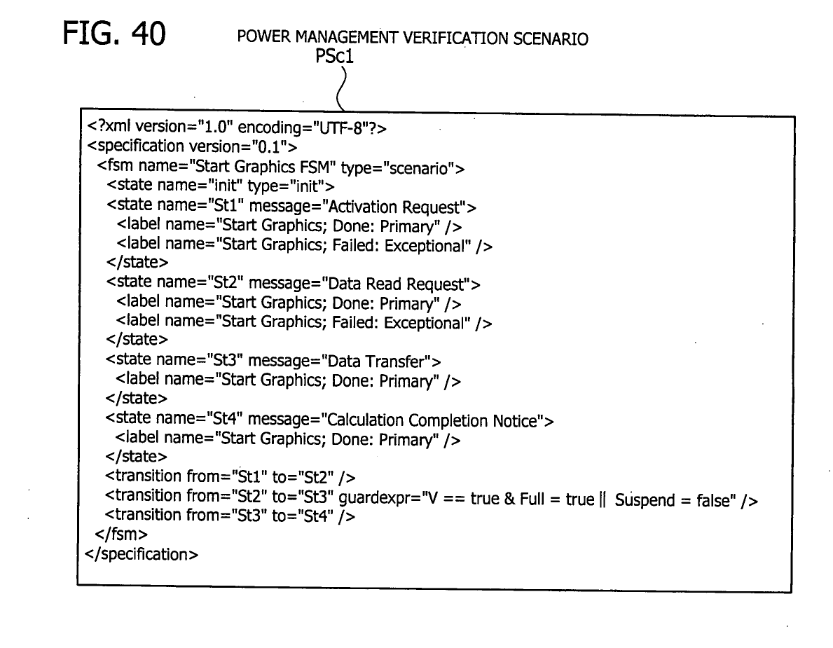

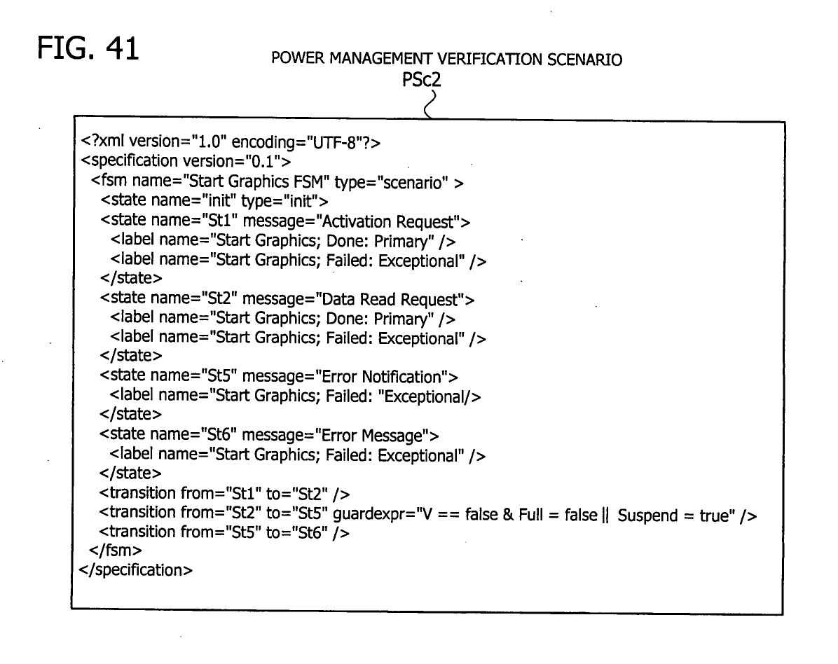

Power management verification scenarios are produced by setting the above two preconditions to the foregoing verification scenarios Sc1 and Sc2, respectively. FIGS. 40 and 41 illustrate a data structure of such power management verification scenarios.

More specifically, FIG. 40 illustrates a data structure of a power management verification scenario PSc1, which executes one message sequence chart 35 named “Query” and makes a subsequent transition to another message sequence chart 36. The third line of this scenario PSc1 reads: <fsm name=“Start Graphics FSM” type=“scenario”>, where the second attribute type=“scenario” indicates that this document describes a verification scenario. The fourth line from the bottom describes a constraint condition that fires a state transition from St2 to St3, which reads: <transition from=“St2” to=“St3” guardexpr=“V==true & Full=true∥Suspend=false”/>.

FIG. 41 illustrates a data structure of another power management verification scenario PSc2, which executes one message sequence chart 35 named “Query” and makes a subsequent transition to another message sequence chart 37. The third line of this scenario PSc2 reads: <fsm name=“Start Graphics FSM” type=“scenario”>, where the second attribute type=“scenario” indicates that this document describes a verification scenario. The fourth line from the bottom of the document describes a constraint condition that fires a state transition from St2 to St5, which reads: <transition from=“St2” to=“St5” guardexpr=“V==false & Full=false∥Suspend =true”/>.

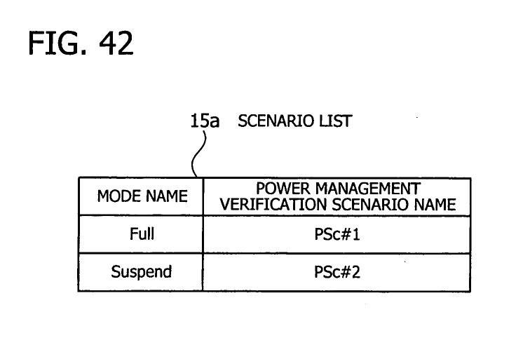

FIG. 42 illustrates a scenario list. This scenario list 15a is formed from a mode name field and a power management verification scenario name field. The field values in a row are associated with each other, thus constituting a single record.

The mode name field contains the name of each mode defined in the power management specification. Specifically, the scenario list 15a of FIG. 42 gives two mode names “Full” and “Suspend.” The power management verification scenario name field contains the name of a power management verification scenario that verifies the mode in the corresponding mode name field. The topmost entry of the illustrated scenario list 15a is of one power management verification scenario PSc1, which is named “PSc#1” and used to verify Full mode. The second entry is of another power management verification scenario PSc2, which is named “PSc#2” and used to verify Suspend mode.

As can be seen from the above description, the proposed design verification apparatus 10 is configured to place constraints on produced verification scenarios, based on a given power management specification. That is, the design verification apparatus 10 generates power management verification scenarios by incorporating mode-specific constraint conditions into the LSI design specification 20. The user verifies his or her design with the resulting mode-specific power management verification scenarios, thereby achieving an exhaustive test of whether the power control signals are exchanged correctly, without leaving out necessary test items or duplicating the same test items.

Specifically, the constraint conditions take effect on scenarios, meaning that a scenario failing to fulfill its constraint conditions will be excluded from the power management verification scenario. On the other hand, the proposed design verification apparatus 10 outputs every verification dataset for testing a scenario that fulfills its constraint conditions. Referring again to the foregoing example discussed in FIGS. 37 to 42, the graphics accelerator 42a is not used in Suspend mode. Accordingly, the verification test can omit verification scenario “Read Data Done” since it uses the graphics accelerator 42a. For this reason, the Full mode operation can be verified by executing a power management verification scenario PSc#1 alone. The Suspend mode operation, on the other hand, can be verified by executing another power management verification scenario PSc#2 alone.

Power management verification scenarios can be used in various phases of the design process. For example, power management verification scenarios may be used to analyze and modify an RTL description produced from an LSI design specification 20. Those power management verification scenarios may be used again to analyze and modify a net list generated from the modified RTL description.

According to the present embodiment, the scenario list 15a is configured to enumerate all mode names and their corresponding power management verification scenarios. The embodiment is, however, not limited by this specific configuration. For example, the user may specify a particular mode before starting verification, and the design verification apparatus 10 then produces a listing of power management verification scenarios applicable to that specified mode.

According to the present embodiment, a precondition table 131b is produced and used to add preconditions to relevant message sequence charts. The embodiment is, however, not limited by this specific configuration. It is also possible to produce a postcondition table and an invariant condition table so as to place postconditions and invariant conditions on relevant message sequence charts.

According to the present embodiment, a mode table 131a and a precondition table 131b are produced and used to place preconditions. The embodiment is, however, not limited by these tables. For example, the embodiment may be modified to use a single hash table where hash values are stored along with merged conditions.

The above-described design verification apparatus 10 uses the following mechanism to produce verification scenarios. That is, a verification scenario generating module 11 is employed to produce verification scenarios for a plurality of processing scenarios defined in a given LSI design specification 20 by assigning appropriate labels to message sequence charts of each processing scenario. This feature makes it possible to identify which message sequence charts constitute a specific scenario.

Also, the verification scenario generating module 11 generates a finite state machine from such message sequence charts, where each state of the produced state machine is assigned the label of its corresponding message sequence chart. This feature makes it possible to identify which states constitute a specific scenario.

Further, the verification scenario generating module 11 extracts a finite state machine corresponding to individual processing scenarios of the given LSI design specification 20, so that a verification scenario can be produced for each extracted finite state machine. This feature makes it possible to produce verification scenarios according to a pattern that the user specifies depending on the progress of design and verification.

According to the present embodiment, the power management specification uses clock gating to manage the power consumption of a device. The embodiment is, however, not limited by this specific power management condition. That is, the power management specification may also specify other conditions based on power gating, dynamic voltage scaling, or other power management techniques, instead of or in addition to the clock gating technique.

For example, power gating conditions may be specified as additional constraint conditions on message sequence charts. Those constraint conditions determine whether to stop power supply, thus enabling the resulting verification scenarios to include power gating control.

Voltage conditions may also be specified as additional constraint conditions on message sequence charts. Those constraint conditions designate, for example, recommended operating voltages, so that the verification process is not allowed to proceed to a message sequence chart if the designated operating voltage is not reached. The resulting verification scenarios are directed solely to the processing scenarios that satisfy the specified voltage conditions.

Frequency conditions may also be specified as additional constraint conditions on message sequence charts. For example, in the case where a high-performance operation is needed, the design specification designates an increased frequency to achieve the desired performance, or varies the operating frequency depending on the specified operating voltage. The resulting verification scenarios are directed solely to the processing scenarios that satisfy the specified frequency conditions.

Further, the constraint conditions on message sequence charts may include conditions of control signals provided to another power management specification. This type of constraint conditions are specified in the case where, for example, the power supply circuit uses an integrated circuit (IC) with a power control bus interface. The resulting verification scenarios thus include control of a power supply IC integrated in or placed outside the LSI circuit under test.

### (l) Additional Power Gating Conditions

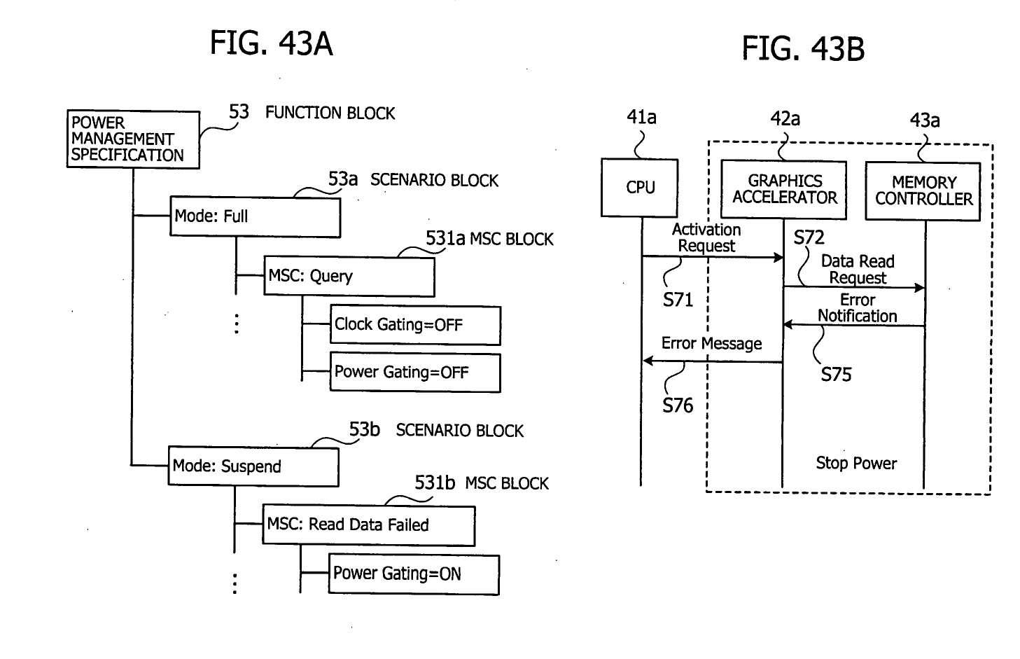

This section describes a power management specification with additional power gating conditions. FIGS. 43A and 43B illustrate a case where some power gating conditions are added to a power management specification. The illustrated power management specification has a scenario block 53a for “Mode: Full” and its constituent message sequence chart with an MSC name of “Query” as indicated by an MSC block 531a. This message sequence chart is given a constraint condition of “Power Gating=OFF” in addition to “Clock Gating=OFF.” Also, the power management specification has a scenario block 53b for “Mode: Suspend” and its constituent message sequence chart with an MSC name of “Read Data Failed” as indicated by an MSC block 531b. This message sequence chart is given a constraint condition of “Power Gating=ON.”

The above-noted additional constraint conditions permit the LSI circuit to activate the power gating function to stop the power to its graphics accelerator 42a and memory controller 43a when it enters Suspend mode. More specifically, the dotted-line box in FIG. 43B indicates the portion where the power will be removed.

The power management specification is used to add preconditions to verification scenarios. With those preconditions, the resulting power management verification scenarios eliminate all processing scenarios relating to the graphics accelerator 42a and memory controller 43a in Suspend mode.

### (m) Power Management of Video Decoder Circuit

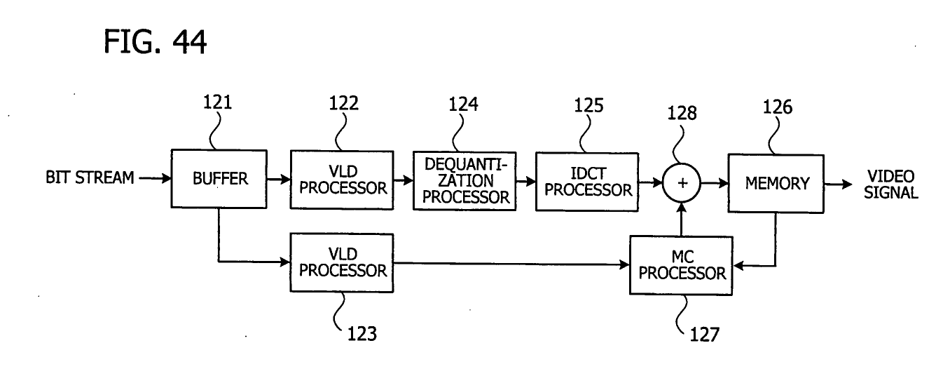

This section will discuss an example of power management specification with additional voltage conditions, assuming that the LSI design specification 20 includes a video decoder circuit illustrated in the block diagram of FIG. 44. The illustrated decoder circuit 120 is formed from a buffer 121, variable-length decoding (VLD) processors 122 and 123, a dequantization processor 124, an inverse discrete cosine transform (IDCT) processor 125, a memory 126, a motion compensation (MC) processor 127, and an adder 128.

The buffer 121 serves as temporary storage for a given video bit stream. This bit stream contains video data compressed by using discrete cosine transform (DCT), quantization, and variable-length coding techniques. The video coding has been made on macroblocks, or groups of neighboring pixels, in each frame of a given video.

Variable-length codewords in the bit stream are decoded by two VLD processors 122 and 123. The former VLD processor 122 outputs quantized DCT coefficients and quantization step sizes, while the latter VLD processor 123 outputs motion vectors.

The dequantization processor 124 dequantizes quantized DCT coefficients, and the IDCT processor 125 performs inverse DCT on the dequantized DCT coefficients, thereby reproducing a prediction error signal. The memory 126 stores several decoded pictures. Based on a decoded picture(s) read out of the memory 126 and the motion vectors supplied from the VLD processor 123, the MC processor 127 produces a motion-compensated prediction picture. The adder 128 adds the prediction error signal to this prediction picture, thus producing another decoded picture.

The power management specification may specify some voltage conditions in its message sequence charts. Such voltage conditions may include those specifying a voltage for the entire object under test (i.e., the entire decoder circuit 120 in the present case), or those specifying voltages used in individual functions of the object.

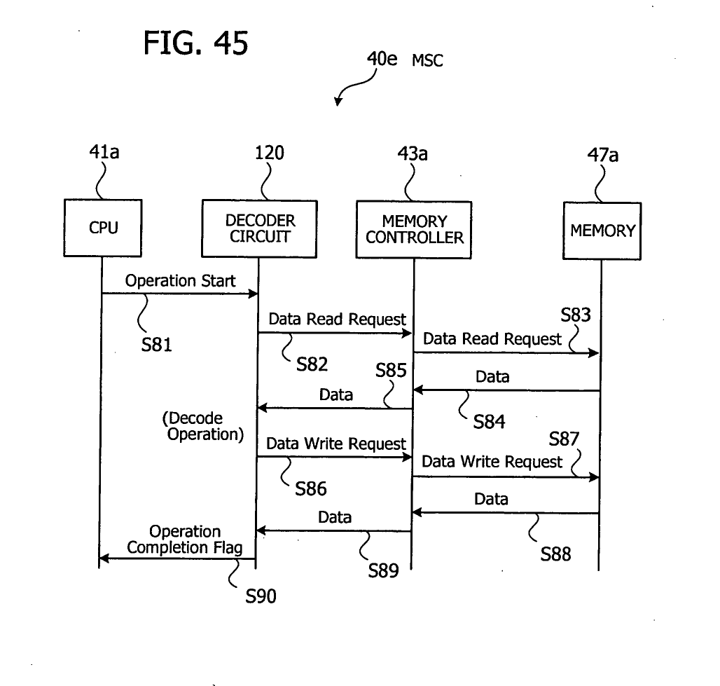

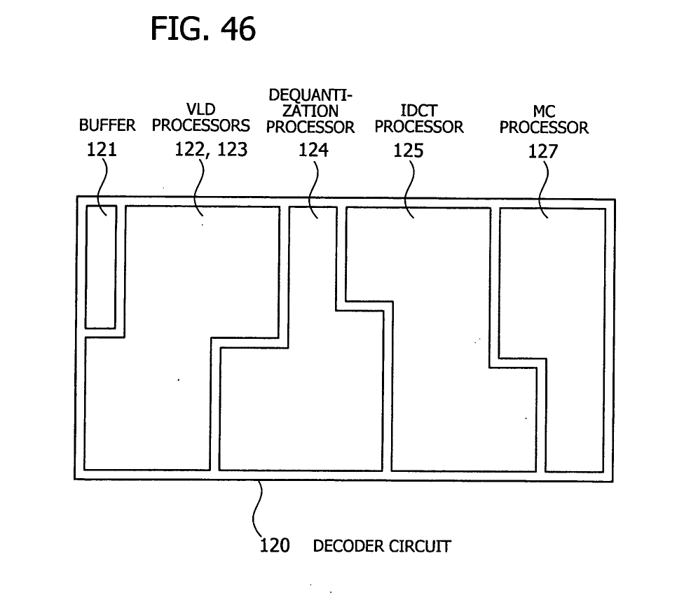

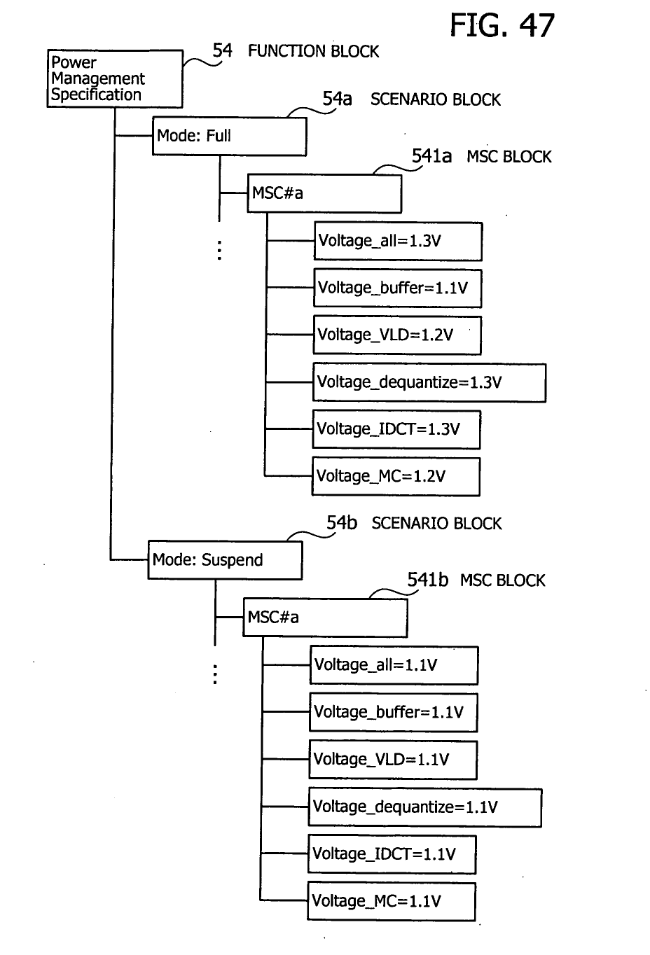

For illustrative purposes, it is assumed that the decoder circuit 120 is treated as a single functional block, while it is actually formed from a plurality of functional blocks as illustrated in FIG. 44. In this case, the decoder circuit 120 appears as one object in a message sequence chart. The power management specification may give a voltage condition for the entire decoder circuit 120 as will be discussed in FIG. 45. Alternatively, the power management specification may give voltage conditions for individual functions of the decoder circuit 120 as will be discussed in FIGS. 46 and 47.

FIG. 45 illustrates a message sequence chart with a voltage condition specifying a voltage for the entire decoder circuit. The illustrated message sequence chart 40e involves the following objects as part of the LSI circuit defined by the LSI design specification 20: CPU 41a, decoder circuit 120, memory controller 43a, and memory 47a. The object with a reference numeral 120 collectively represents a plurality of functions constituting the decoder circuit 120.

The message sequence chart 40e actually includes two message sequence charts named “Query” and “Read Data Done.” Specifically, the illustrated sequence proceeds as follows: At the outset, the CPU 41a sends an operation start command to the decoder circuit 120 (step S81). In response, the decoder circuit 120 initiates a data read request to the memory controller 43a (step S82). The memory controller 43a forwards this data read request to the memory 47a (step S83). Upon receipt of the data read request, the memory 47a transfers the requested data back to the memory controller 43a (step S84). The memory controller 43a forwards this data to the decoder circuit 120 (step S85). The decoder circuit 120 performs its operation with the received data and sends a data write request to the memory controller 43a upon completion of the operation (step S86). The memory controller 43a forwards the data write request to the memory 47a (step S87). The memory 47a sends data corresponding to the data write request to the memory controller 43a (step S88). The memory controller 43a forwards this data to the decoder circuit 120 (step S89). The decoder circuit 120 sends an operation completion notice (flag) to the CPU 41a (step S90).

FIG. 46 illustrates an example layout of functions of the decoder circuit 120. The functions arranged in separate areas may be supplied with a different set of operating voltages, depending on what mode the decoder circuit 120 is in.

FIG. 47 illustrates a power management specification with voltage conditions. According to this example structure, the message sequence charts realizing the foregoing decoder circuit 120 have a plurality of subordinate hMSCs, each of which is given a voltage constraint condition. Specifically, the power management specification defined in a function block 54 includes two scenarios, i.e., “Mode: Full” and “Mode: Suspend” in scenario blocks 54a and 54b. Scenario “Mode: Full” is realized by several message sequence charts, including the one named “MSC#a” as seen in an MSC block 541a. Likewise, scenario “Mode: Suspend” is realized by several message sequence charts, including the one named “MSC#a” as seen in another MSC block 541b.

According to the power management specification of FIG. 47, message sequence chart MSC#a for scenario “Mode: Full” is given the following set of constraint conditions:

Voltage_all=1.3V

Voltage_buffer=1.1V

Voltage_VLD=1.2V

Voltage_dequantize=1.3V

Voltage_IDCT=1.3V

Voltage_MC=1.2V

Here, “Voltage_all=1.3V” is a voltage constraint condition to be applied when activating every function of the circuit in Full mode. “Voltage_buffer=1.1V” is a voltage constraint condition to be applied when activating the buffer 121 in Full mode. “Voltage_VLD=1.2V” is a voltage constraint condition to be applied when activating the VLD processors 122 and 123 in Full mode. “Voltage_dequantize=1.3V” is a voltage constraint condition to be applied when activating the dequantization processor 124 in Full mode. “Voltage_IDCT=1.3V” is a voltage constraint condition to be applied when activating the IDCT processor 125 in Full mode. “Voltage_MC=1.2V” is a voltage constraint condition to be applied when activating the MC processor 127 in Full mode.

On the other hand, message sequence chart MSC#a for scenario “Mode: Suspend” have a different set of constraint conditions as follows:

Voltage_all=1.1V

Voltage_buffer=1.1V

Voltage_VLD=1.1V

Voltage_dequantize=1.1V

Voltage_IDCT=1.1V

Voltage_MC=1.1V

Here, “Voltage_all=1.1V” is a voltage constraint condition to be applied when activating every function of the circuit in Suspend mode. “Voltage_buffer=1.1V” is a voltage constraint condition to be applied when activating the buffer 121 in Suspend mode. “Voltage_VLD=1.1V” is a voltage constraint condition to be applied when activating the VLD processors 122 and 123 in Suspend mode. “Voltage_dequantize=1.1V” is a voltage constraint condition to be applied when activating the dequantization processor 124 in Suspend mode. “Voltage_IDCT=1.1V” is a voltage constraint condition to be applied when activating the IDCT processor 125 in Suspend mode. “Voltage_MC=1.1V” is a voltage constraint condition to be applied when activating the MC processor 127 in Suspend mode.

The above-described power management specification places various voltage constraint conditions on verification scenarios when they are produced. Accordingly, the resulting power management verification scenarios do not include any processing scenarios whose message sequence chart assumes other voltages than the specified voltages in Full mode. Suppose, for example, that there is a processing scenario that includes a message sequence chart having “Voltage_all=1.3V” in its constraint conditions. This scenario is rejected for the listing of power management verification scenarios if its constraint condition on the buffer voltage is not “Voltage_buffer=1.1V.”

Similarly to the Full mode described above, the power management verification scenarios do not include any processing scenarios whose message sequence chart assumes other supply voltages than 1.1 V when the functions of the decoder circuit 120 are in Suspend mode.

### (n) Variations of Embodiment

According to the present embodiment, power management specifications are used as a source of constraint conditions. The embodiment is, however, not limited by this type of specifications. For example, it is also possible to use other various specifications about the product under test, such as those for management of performance (operating speed).

According to the present embodiment, verification scenarios are produced based on two types of specifications (i.e., functional specifications and power management specifications). The embodiment is, however, not limited by this particular number of specifications. It is also possible to use three or more types of specifications to generate verification scenarios.

As still another variation of the present embodiment, the processing functions of the design verification apparatus 10 may be distributed in a plurality of processing devices. For example, one processing device generates verification scenarios and passes them to another device to produce power management verification scenarios.

### (o) Computer-Readable Storage Media

The processing functions described above may be implemented on a computer system, in which case the functions of the proposed design verification apparatus 10 are encoded and provided in the form of computer programs. A computer system executes such programs to provide the above-described processing functions. Those computer programs may be stored in a computer-readable storage medium. Suitable computer-readable storage media include, but not limited to, magnetic storage devices, optical discs, magneto-optical storage media, and semiconductor memory devices, for example. Magnetic storage devices include hard disk drives (HDD), flexible disks (FD), and magnetic tapes, for example. Optical discs include digital versatile discs (DVD), DVD-RAM, compact disc read-only memory (CD-ROM), CD-Recordable (CD-R), and CD-Rewritable (CD-RW), for example. Magneto-optical storage media include magneto-optical discs (MO), for example.

Portable storage media, such as DVD and CD-ROM, are suitable for distribution of program products. Network-based distribution of software programs may also be possible, in which case several master program files are made available on a server computer for downloading to other computers via a network.

To execute a design verification program, the computer stores necessary software components in its local storage device, which have previously been installed from a portable storage media or downloaded from a server computer. The computer executes the programs read out of the local storage unit, thereby performing the programmed functions. Where appropriate, the user computer may execute program codes read out of the portable storage medium, without previous installation of those programs in its local storage device. Another alternative method is that the user computer dynamically downloads programs from a server computer when they are demanded and executes them upon delivery.

### CONCLUSION

The above sections have described several embodiments of a design verification apparatus and a program therefor. The proposed design verification techniques provide verification datasets for a comprehensive test including relevant constraint conditions of test items described in given design specifications. The features described in those embodiments may be combined on an individual basis.

All examples and conditional language recited herein are intended for pedagogical purposes to aid the reader in understanding the invention and the concepts contributed by the inventor to furthering the art, and are to be construed as being without limitation to such specifically recited examples and conditions, nor does the organization of such examples in the specification relate to a showing of the superiority and inferiority of the invention. Although the embodiments of the present invention have been described in detail, it should be understood that various changes, substitutions, and alterations could be made hereto without departing from the spirit and scope of the invention.

What is claimed is:

1. A design verification apparatus comprising:
a processor to produce and place constraint conditions on verification datasets provided to verify a first design specification of a target product, the constraint conditions being produced from a second design specification of the target product, based on links from units of processing which constitute a procedure defined for each verification item in the second design specification to units of processing in the first design specification, and
to output data identifying the verification datasets with the constraint conditions placed by the constraint setting module, together with the verification items corresponding thereto.

2. The design verification apparatus according to claim 1, wherein:
the second design specification comprises a plurality of procedures; and
the processor produces the constraint conditions each being a condition specifying transition to one of the procedures whose units of processing are linked to a particular unit of processing of the first design specification.

3. The design verification apparatus according to claim 1, wherein the processor generates the verification datasets by giving an identifier designating which portion of the first design specification is to be verified, to each unit of processing of a plurality of procedures defined in the first design specification.

4. The design verification apparatus according to claim 3, wherein the processor extracts a set of units of processing that share a specific identifier and outputs the extracted set of units of processing as a verification dataset.

5. The design verification apparatus according to claim 3, wherein:
the units of processing in the first and second design specifications each comprise a sequence of signals exchanged between objects; and
the processor associates each sequence with the identifier of the corresponding unit of processing.

6. The design verification apparatus according to claim 5, wherein the processor produces a state machine from the sequences and assigns the identifiers of the corresponding source sequences to states of the produced state machine.

7. The design verification apparatus according to claim 6, wherein:
the identifier designates a function, or a procedure, or a sequence, or a combination thereof, as said portion of the first design specification to be verified; and
the processor extracts a part of the state machine whose states share a specific identifier, and outputs the extracted part of the state machine as a verification dataset.

8. The design verification apparatus according to claim 6, wherein the processor reduces the number of states of the sequences, based on a specified constraint on the sequences.

9. A non-transitory computer-readable storage medium encoded with a design verification program which causes a computer to perform a procedure, the procedure comprising:
receiving first and second design specifications of a target product;
producing constraint conditions from the second design specification, based on links from units of processing which constitute an operation procedure defined for each verification item in the second design specification to units of processing in the first design specification;
placing the produced constraint conditions on verification datasets provided to verify the first design specification; and
outputting data identifying the verification datasets with the constraint conditions, together with the verification items corresponding thereto.

10. The non-transitory computer-readable storage medium according to claim 9, wherein:
the second design specification comprises a plurality of operation procedures; and
said producing produces the constraint conditions each being a condition specifying transition to one of the operation procedures whose units of processing are linked to a particular unit of processing of the first design specification.

11. The non-transitory computer-readable storage medium according to claim 9, wherein the procedure further comprises generating the verification datasets by giving an identifier designating which portion of the first design specification is to be verified, to each unit of processing of a plurality of operation procedures defined in the first design specification.

12. The non-transitory computer-readable storage medium according to claim 11, wherein said generating extracts a set of units of processing that share a specific identifier and outputs the extracted set of units of processing as a verification dataset.

13. The non-transitory computer-readable storage medium according to claim 11, wherein:
the units of processing in the first and second design specifications each comprise a sequence of signals exchanged between objects; and
said generating associates each sequence with the identifier of the corresponding unit of processing.

14. The non-transitory computer-readable storage medium according to claim 13, wherein the processor produces a state machine from the sequences and assigns the identifiers of the corresponding source sequences to states of the produced state machine.

15. The non-transitory computer-readable storage medium according to claim 14, wherein:
the identifier designates a function, or an operation procedure, or a sequence, or a combination thereof, as said portion of the first design specification to be verified; and
said generating extracts a part of the state machine whose states share a specific identifier, and outputs the extracted part of the state machine as a verification dataset.

16. The non-transitory computer-readable storage medium according to claim 14, wherein the procedure further comprises reducing the number of states of the sequences, based on a specified constraint on the sequences.

17. A design verification apparatus comprising:
means for producing and placing constraint conditions on verification datasets provided to verify a first design specification of a target product, the constraint conditions being produced from a second design specification of the target product, based on links from units of processing which constitute an operation procedure defined for each verification item in the second design specification to units of processing in the first design specification; and
means for outputting data identifying the verification datasets with the constraint conditions placed by the constraint setting module, together with the verification items corresponding thereto.
